(19) United States
(12) Patent Application Publication
(10) Pub. No.: US 2008/0103245 A1
(43) Pub. Date: May 1, 2008

(54) Inorganic Fine Particle Dispersion Liquid, Method For Producing Inorganic Fine Particle Dispersion Liquid, And Inkjet Recording Medium Using The Same

(75) Inventors: Toshiaki Endo, Shizuoka (JP); Kozo Nagata, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: Fujifilm Corporation, Minato-ku (JP)

(21) Appl. No.: 11/667,444

(22) PCT Filed: Nov. 11, 2005
(86) PCT No.: PCT/JP05/21179

§ 371 Date: May 10, 2007

(30) Foreign Application Priority Data
Nov. 12, 2004 (JP) 2004-329634
Feb. 4, 2005 (JP) 2005-029771
Sep. 20, 2005 (JP) 2005-272815

(51) Int. Cl. B01F 3/12; C08K 3/36; C08L 29/04; C08L 75/04

(52) U.S. Cl. 524/543; 516/80; 524/591

(57) ABSTRACT

A method of producing an inorganic fine particle dispersion liquid, the method comprising subjecting a dispersion liquid including a water-soluble organic cationic compound, a water-soluble polyvalent metal compound, and inorganic fine particles to a dispersing process by a head-on collision high-pressure dispersing machine or an orifice-passage high-pressure dispersing machine. Also provided is an inorganic fine particle dispersion liquid and an inkjet recording medium using the same.

### TECHNICAL FIELD

The invention is related to an inorganic fine particle dispersion liquid with superior stability over time, a method for producing the same, and an inkjet recording medium. In particular, the invention is concerned with an inkjet recording medium with high gloss, high image density, and suppressed bleeding of image over time.

### BACKGROUND ART

Inkjet recording media are produced usually by coating a coating liquid for an ink-receiving layer on a support followed by drying. A generally-known method for preparing the coating liquid for an ink-receiving layer is a method of adding an aqueous solution of a hydrophilic binder (such as polyvinyl alcohol) and other additives (such as cationic polymers, hardener, and surfactants) to a dispersion liquid of inorganic fine particles such as silica fine particles.

The inorganic fine particles are preferably inorganic pigment fine particles whose examples include silica fine particles, colloidal silica, titanium dioxide, barium sulfate, calcium silicate, zeolite, kaolinite, halloysite, mica, talc, calcium carbonate, magnesium carbonate, calcium sulfate, alumina, boehmite, and pseudo-boehmite. Silica fine particles are preferable from the viewpoints of ink absorptivity and high color density.

The silica contained in the silica dispersion liquid is preferably a vapor-phase-method silica (fumed silica) produced by burning silicon tetrachloride as a raw material in oxyhydrogen flame or a wet-method silica (for example, a precipitated silica obtained by neutralization of sodium silicate or a gel-method silica) or a sol-gel-method silica obtained by hydrolysis of an alkoxide of silicon as a raw material in an alkaline or acidic water-containing organic solvent. Silica dispersion liquids using such silicas have attracted attention.

In the field of inkjet recording media, there have been needs for photo-like media, which are high in gloss, color saturation, and ink absorptivity. In order to make inkjet recording media having such characteristics, it is preferable to use very fine particles having an average primary particle diameter of 50 nm or less, and vapor-phase-method silica or alumina sol is preferably used. For example, recording materials have been proposed, for example in the following documents, which are produced by coating silica fine particles and a hydrophilic binder on a paper support: Japanese Patent Application Laid-Open (JP-A) Nos. 55-51583, 56-157, 57-107879, 57-107880, 59-230787, 62-160277, 62-184879, 62-183382, and 64-11877.

Inkjet recording media using synthetic silica fine particles produced by a vapor-phase method (hereinafter referred to as “vapor-phase-method silica”) have been proposed, for example in the following documents: Japanese Patent Publication (JP-B) No. 3-56552 and JP-A Nos. 2-188287, 10-20306, 10-81064, 10-100397, 10-119423, and 10-203006.

However, the dispersion liquid of the very fine particles is disadvantageous in that its dispersion stability is inferior and that the fine particles easily aggregate. Particularly when the dispersion liquid of the inorganic fine particles is used in a coating liquid for an inkjet receiving layer of an inkjet recording medium, the inorganic fine particles aggregate more easily because of the inferior dispersion stability. As the result, problems are caused such as the occurrence of ink repellence or streak-like coating defects and decrease in ink absorptivity.

The use of metal in an inkjet recording medium for the improvement of image storability has been known. For example, the use of basic polyaluminum hydroxide has been reported (for example in JP-A Nos. 60-257286 and 61-16884). Further, the use of elements of the group 4A of the Periodic Table and aluminum compounds is described in JP-A Nos. 6-32064, 10-258567, 10-309862, and 2000-309157. However, these patent documents do not teach dispersing of inorganic fine particles in the presence of the metal compounds.

Usually, silica dispersion liquids are prepared by: subjecting inorganic fine particles to a primary dispersing (premixing) in a dispersion medium (water, an organic solvent, or a mixture of liquids selected from water and organic solvents) to form inorganic fine particle slurry and then subjecting the inorganic fine particle slurry to a secondary dispersing conducted by a dispersing machine such as a sand mill or a ball mill.

However, the particle size of the silica dispersion liquid produced by using a dispersing machine such as a ball mill or a sand grinder is large, and the transparency of the silica dispersion liquid is low. Therefore, the gloss of the inkjet recording medium produced by using the silica dispersion liquid is not satisfactory.

Further, the vapor-phase-method silica has inferior dispersion stability. This is because the vapor-phase method silica has only a few silanol groups on its surface. Although use of a cationic polymer is known to improve the ink (dye) fixability, the silica fine particles aggregate upon mixing of the silica dispersion liquid and the cationic polymer. Towards this problem, a technique of dispersing the silica fine particles in the presence of a cationic polymer so as to improve the dispersion stability of the silica fine particles has been disclosed, (for example in JP-A Nos. 11-20306, 11-105411, 11-321079, and 2001-19421).

### DISCLOSURE OF INVENTION

An object of the present invention is to provide an inkjet recording medium with high gloss, high color density, improved bleeding over time, and superior gas resistance.

In consideration of the above problems of the conventional techniques, the inventors of the present invention have conducted intensive research. As a result, the inventors have found that the object can be achieved by atomizing the silica particles by high-pressure dispersing, whereby the inventors have made the present invention.

The invention provides a method for producing an inorganic fine particle dispersion liquid, the method comprising subjecting a dispersion liquid including a water-soluble organic cationic compound, a water-soluble polyvalent metal compound, and inorganic fine particles to a dispersing process by a head-on collision-type high-pressure dispersing machine or an orifice-passage-type high-pressure dispersing machine. The processing pressure of the head-on collision-type high-pressure dispersing machine may be 50 MPa or more. The pressure difference between the entry-side and exit-side of an orifice of the orifice passage-type high-pressure dispersing machine may be 50 MPa or more. The average primary particle diameter of the inorganic fine particles may be 30 nm or less, and the average secondary particle diameter of the inorganic fine particles after dispersion may be 200 nm or less. The inorganic fine particles may be vapor-phase-method silica. The specific surface area of the inorganic fine particles according to BET method may be not lower than 200 m²/g. The water-soluble polyvalent metal compound may be a tri- or higher-valent metal compound. The water-soluble trivalent or higher valent metal compound may be a water-soluble aluminum compound and/or a water-soluble zirconium compound. The water-soluble organic cationic compound may be a compound having a primary to tertiary amino group, a quaternary ammonium base, or a phosphonium base. At least one water-soluble polyvalent metal compound may be one or more compounds selected from the group consisting of zirconyl acetate, ammonium zirconyl carbonate, and basic polyaluminum hydroxide.

The invention also provides an inorganic fine particle dispersion liquid produced by any of the above methods for producing an inorganic fine particle dispersion liquid.

The invention further provides an inkjet recording medium having an ink-receiving layer prepared by applying a coating liquid including the inorganic fine particle dispersion liquid. The coating liquid may include a water-soluble resin, a crosslinking agent, a surfactant, and the inorganic fine particle dispersion liquid. The coating liquid may include a water-soluble resin, a crosslinking agent, a surfactant, a water-soluble organic solvent having a boiling point of 150° C. or more, a water-dispersible cationic resin, and the inorganic fine particle dispersion liquid. The water-soluble resin may be a polyvinyl-alcohol-based resin. The water-soluble resin, the surfactant and the water-soluble organic solvent having a boiling point of 150° C. or more may be co-dissolved in an aqueous solution (aqueous medium). The crosslinking agent may be boric acid. The water-dispersible cationic resin may be a urethane resin.

According to the invention, the transparency of the dispersion liquid processed by a head-on collision-type high-pressure dispersing machine or by an orifice passage-type high-pressure dispersing machine is high, and an inkjet image-receiving paper produced using the dispersion liquid is highly glossy with high-density coloration.

### BEST MODE FOR CARRYING OUT THE INVENTION

The method for producing an inorganic fine particle dispersion liquid according to the present invention comprises dispersing inorganic fine particles in the presence of a water-soluble organic cationic compound and a water-soluble polyvalent metal compound using a head-on collision-type high-pressure dispersing machine or an orifice passage-type high-pressure dispersing machine.

The inorganic fine particle dispersion liquid of the invention is produced by the method described above.

The inkjet recording medium of the invention comprises an ink-receiving layer prepared by applying a coating liquid including the inorganic fine particle dispersion liquid.

Preferably, the inkjet recording medium of the invention has an ink-receiving layer prepared by applying a coating liquid that is produced using a water-soluble resin, a crosslinking agent, a surfactant, and the inorganic fine particle dispersion liquid described above.

Preferably, the inkjet recording medium of the invention has an ink-receiving layer prepared by coating a coating liquid containing the inorganic fine particle dispersion liquid of the invention, a water-soluble resin, a crosslinking agent, a surfactant, a water-soluble organic solvent having a boiling point of 150° C. or more, and a water-dispersible cationic resin.

The transparency of the inorganic fine particle dispersion liquid produced by the above dispersing treatment and the transparency of the ink-receiving layer coating liquid are high, and inkjet recording media produced using them can exhibit high-density coloration with high gloss.

Hereinafter, the inorganic fine particle dispersion liquid of the invention, a method for producing the same, and an inkjet recording medium are described in detail.

In the inkjet recording medium of the invention, the inorganic fine particles are not particularly limited, and examples thereof include fine particles of synthetic silica, alumina hydrate, calcium carbonate, barium sulfate, etc. Among them, synthetic silica is preferable, and particularly, silica fine particles synthesized by a vapor-phase method are preferable.

The specific surface area of the inorganic fine particles in the invention, as determined by a BET method, is preferably 200 m²/g or more, more preferably 250 m²/g or more, still more preferably 270 m²/g or more. The upper limit of the specific surface area thereof is preferably 400 m²/g or less.

The inkjet recording medium of the invention comprises a support, at least one ink-receiving layer provided on the support, and other optional layers. The ink-receiving layer according to the invention is prepared by applying a coating liquid containing a water-soluble resin, a crosslinking agent, a surfactant, a water-soluble organic solvent having a boiling point of 150° C. or more, a water-dispersible cationic resin, and the inorganic fine particle dispersion liquid described above.

As described above, the inorganic fine particles preferably include vapor-phase-method silica having a specific surface area of 200 m²/g or more determined by BET method.

The coating liquid comprises a water-soluble polyvalent metal compound (for example, ammonium zirconyl carbonate etc.) described later and optionally ammonium water. If necessary, the coating liquid may further comprise other ingredients such as a mordant.

The ink-receiving layer has a porous structure owing to the presence of vapor-phase-method silica described later as the inorganic fine particles, and when the silica particles have such a small diameter that the specific surface area determined by BET method is 200 m²/g or more, ink absorptivity and printing density can be further improved.

The ink-receiving layer according to the invention can be formed preferably by a wet-on-wet method (WOW method) as described later. Specific procedures will be described later. Because the ink-receiving layer should have enough absorption capacity to absorb all liquid droplets in inkjet recording, its thickness should be determined in relationship to the void volume of the layer. For example, when the amount of ink is 8 nL/mm² and the void volume is 60%, the layer should have a thickness of about 15 μm or more. Specifically, the thickness of the ink-receiving layer is preferably 10 to 50 μm.

Hereinafter, the respective components constituting the ink-receiving layer according to the invention are described in detail.

The ink-receiving layer according to the invention preferably contains vapor-phase-method silica having a specific surface area of at least 200 m²/g or more determined by BET method (hereinafter, referred to as “silica fine particles”) as the inorganic particles in order to constitute a porous structure. The presence of vapor-phase-method silica provides a porous structure, whereby ink absorptivity can be improved. By increasing the specific surface area to not smaller than 200 m²/g, higher ink absorption, quicker drying, and less ink blurring are achieved, and image quality and printing density are readily improved.

The inorganic fine particle dispersion liquid of the invention (for example, the silica dispersion liquid) can be kept stably for a long period of time even if the concentration of the inorganic fine particles (e.g., silica) is high, that is, at 15 wt % or more, even at 18 wt % or more. The concentration of the inorganic fine particles is preferably 30% or less.

The dispersing medium used in the preparation of the inorganic fine particle dispersion liquid of the invention (for example, the silica dispersion liquid) comprises water as the main component. In a preferable embodiment, the dispersing medium further comprises a small amount of an organic solvent (a low-boiling solvent such as a lower alcohol or an ethyl acetate). In this case, the amount of the organic solvent is preferably 20 wt % or less, more preferably 10 wt % or less, based on the entire dispersing medium.

Now, the method for producing an inorganic fine particle dispersion liquid according to the invention is described in detail with reference to production of a silica dispersion liquid, but the invention is not limited thereto.

Usually, the silica dispersion liquid is obtained by a method comprising: adding silica fine particles to a dispersing medium such as water, and mixing them (preliminary mixing); then adding a cationic resin and a water-soluble polyvalent metal compound to the mixture to prepare a silica slurry (preliminary dispersion); and dispersing the silica slurry using a dispersing machine in a liquid-liquid head-on collision system, (e.g., ALTIMIZER manufactured by Sugino Machine Incorporated). The number of times the silica slurry is treated by Altimizer is selected in the range of one to several tens times.

Synthetic silica can be produced by a wet method or a vapor-phase method, and generally, the silica fine particles refer often to wet-method silica. Examples of the wet-method silica include (1) silica sol obtained by double decomposition of sodium silicate with an acid etc. or by passing sodium silicate through an ion-exchange resin layer, (2) colloidal silica obtained by thermal aging of the silica sol, (3) silica gel in the form of three-dimensional secondary particles containing primary particles bound via siloxane linkages to one another having a particle size of several micron to about 10 microns formed by gelling the silica sol under any of various formation conditions, and (4) silicic-acid-based synthetic silicic acid compounds obtained by heating silica sol, sodium silicate, sodium aluminate etc.

The vapor-phase-method silica is also called dry-method silica as opposed to wet-method silica, and is produced generally by flame hydrolysis. Specifically, a method which involves burning silicon tetrachloride together with hydrogen and oxygen to produce vapor-phase-method silica is generally known. In the method, in place of silicon tetrachloride, silanes such as methyl trichlorosilane and trichlorosilane can also be used alone or in a state of being mixed with silicon tetrachloride. The vapor-phase-method silica is commercially available as AEROSIL from Nippon Aerosil Co., Ltd., or as QS series from Tokuyama Corp.

The vapor-phase-method silica, as compared with the wet-method silica, easily forms a three-dimensional structure of high porosity, and thus is preferable for use in the inkjet recording medium of the invention. The reason for this is not evident, and is considered attributable to the density of surface silanol groups. That is, it is considered that as compared with the wet-method silica, the vapor-phase-method silica has a lower density of silanol groups on the surface, and thus sparsely flocculates to form a structure of high porosity. Increasing the void volume of the ink-receiving layer is very important in increasing ink absorption speed and absorption capacity.

BET method referred to in the invention is a method of measuring the surface area of powder by a vapor-phase adsorption method. In BET method, the total surface area of 1 g of the sample, that is, the specific surface area, is determined from the adsorption isothermal curve. Usually, nitrogen gas is often used as the gas to be adsorbed in this method, and the amount of the gas adsorbed is determined often from the change in pressure or volume of the gas for adsorption. The most famous formula indicating the isothermal curve of multimolecular adsorption is the Brunauer, Emmett and Teller formula, which is called “BET formula” and used widely in determination of surface area. The amount of adsorbed gas is determined based on BET formula and then multiplied by the area occupied by one adsorbed molecule on the surface, to give the surface area.

Generally, the silica fine particles are classified roughly into wet-method particles and dry-method (vapor-phase method) particles, depending on the method for producing silica, and the vapor-phase-method silica in the invention is dry method (vapor-phase method) particles. The mainstream of vapor-phase methods is a method involving hydrolysis of silicon halides in a vapor-phase at a high temperature to form a wet-method silica (flame hydrolysis method) or a method involving heating, reducing and gasifying borax and coke by an arc in an electric oven and oxidizing the resulting gas with air to form a wet-method silica (arc method), and the “vapor-phase-method silica” refers to a wet-method silica fine particles obtained by the vapor-phase method. The mainstream of wet methods involves decomposing a silicate with acid to form activated silica and then polymerizing the activated silica to an appropriate degree to allow the aggregates to precipitate, thereby obtaining a hydrous silica. The wet-method silica may be used in combination with the vapor-phase-method silica.

Since the vapor-phase-method silica is different from the hydrous silica in density of surface silanol groups and degree of voids, the vapor-phase-method silica has different properties from the hydrous silica, and is suitable for the formation of a three-dimensional structure having high void ratio. The reason for this is supposedly as follows: because the density of silanol groups on the surfaces of the fine particles is as many as 5 to 8 pieces/nm² in the case of hydrous silica, the silica particles densely aggregate easily. In contrast, because the density of silanol groups on the surfaces of the fine particles is as few as 2 to 3 pieces/nm² in the case of vapor-phase-method silica, the silica particles sparsely flocculate to give a high void ratio.

Since the vapor-phase-method silica has a particularly large specific surface area, it has high ink absorbing property and high ink holding efficiency. Since the vapor-phase-method silica has a low refractive index, the transparency can be imparted to the ink-receiving layer when the vapor-phase-method silica particles are dispersed to have an appropriate particle diameter, whereby high color density and excellent color development can be obtained. The transparency of the ink-receiving layer is important in view of obtaining high color density and superior color glossiness even when the ink-receiving layer is used in photographic glossy paper or the like.

The total content (solids content) of the vapor-phase-method silica (and other fine inorganic particles if necessary) in the ink-receiving layer is preferably 60 wt % or more, more preferably 65 wt % or more. A total content of 60 wt % or more is preferable because a further excellent porous structure can be formed to provide an inkjet recording sheet with sufficient ink absorptivity. The amount (solids content) in the ink-receiving layer is an amount calculated based on the components other than water in the composition constituting the ink-receiving layer.

When the vapor-phase-method silica (and other inorganic fine particles if necessary) is used in the inkjet recording sheet, the silica can also be used preferably in the embodiments described in for example JP-A No. 10-81064, JP-A No. 10-119423, JP-A No. 10-157277, JP-A No. 10-217601, JP-A No. 11-348409, JP-A No. 2001-138621, JP-A No. 2000-43401, JP-A No. 2000-211235, JP-A No. 2000-309157, JP-A No. 2001-96897, JP-A No. 2001-138627, JP-A No. 11-91242, JP-A No. 8-2087, JP-A No. 8-2090, JP-A No. 8-2091, JP-A No. 8-2093, JP-A No. 8-174992, JP-A No. 11-192777 and JP-A No. 2001-301314.

For the purpose of improving dispersibility, the surfaces of the vapor-phase-method silica fine particles may be treated with a silane coupling agent. The silane coupling agent preferably has an organic functional group (for example, a vinyl group, an amino group, an epoxy group, a mercapto group, a chloro group, an alkyl group, a phenyl group, an ester group etc.) in addition to the site for coupling.

Hereinafter, the method for producing an inorganic fine particle dispersion liquid by dispersing inorganic fine particles according to the invention is described in detail. Hereinafter, the method is described in detail with reference to production of vapor-phase-method silica as an example of the inorganic fine particles, but the invention is not limited thereto.

The method for producing an inorganic fine particle dispersion liquid according to the invention comprises subjecting a dispersion liquid (preliminarily dispersed liquid) containing a water-soluble organic cationic compound, a water-soluble polyvalent metal compound, and inorganic fine particles to a dispersing treatment involving use of a high-pressure dispersing machine to cause head-on collision or to allow the preliminarily dispersed liquid to pass through an orifice.

The method for producing an inorganic fine particle dispersion liquid according to the invention is not particularly limited insofar as a preliminary dispersed liquid obtained by preliminarily dispersing the inorganic fine particles (silica), a water-soluble organic cationic polymer and a water-soluble polyvalent metal compound in a solvent undergoes head-on collision at high pressure or passes through an orifice at high pressure. In general, commercially-available apparatuses called “high-pressure homogenizers” can be used advantageously.

Typical examples of high-pressure homogenizers include NANOMIZER (LA-31) (trade name) manufactured by Nanomizer, MICROFLUIDIZER (trade name) manufactured by Microfluidix, and ALTIMIZER manufactured by Sugino Machine Incorporated.

The orifice refers to a mechanism in which a thin plate (orifice plate) having a minute hole (whose shape may be a circle or the like) is disposed in a straight pipe to rapidly reduce the sectional area of the flow path in the straight pipe.

The high-pressure homogenizer is an apparatus basically comprises a high-pressure generating part that pressurizes the starting slurry etc. and a head-on collision part or an orifice part. As the high-pressure generating part, a high-pressure pump generally called a plunger pump can be used advantageously. There are various high-pressure pumps, such as high-pressure pumps of single-line, double-line and triple-line systems, any of which can be used in the invention without particular limitation.

The processing pressure for the high-pressure head-on collision described above may be 50 MPa or more, preferably 100 MPa or more, more preferably 130 MPa or more.

Similarly to the processing pressure described above, the pressure difference between the entry-side and exit-side of the orifice, upon passage of the starting slurry, may be 50 MPa or more, preferably 100 MPa or more, more preferably 130 MPa or more. Each of the processing pressure and the pressure difference is preferably 350 MPa or less.

The dispersing efficiency in each method depends on the processing pressure, and thus the dispersion efficiency is increased as the processing pressure is increased. When the processing pressure is higher than 350 MPa, however, problems are likely to occur in the pressure resistance of the piping of the high-pressure pump and in the durability of the apparatus.

In each method, the number of times the dispersing treatment is conducted is not particularly limited, and usually is selected suitably from the range of 1 to several tens times. The inorganic fine particle dispersion liquid of the invention can thereby be obtained.

Various additives may also be added during the preparation of the dispersion liquid.

Examples of the additives include a wide variety of nonionic or cationic surfactants (anionic surfactants are not preferable because they form aggregates), defoaming agents, nonionic hydrophilic polymers (e.g., polyvinyl alcohol, polyvinyl pyrrolidone, polyethylene oxide, polyacrylamide, various sugars, gelatin, pullulan), nonionic or cationic latex dispersion liquids, water-miscible organic solvents (e.g., ethyl acetate, methanol, ethanol, isopropanol, n-propanol, acetone), inorganic salts, and pH adjusting agents. These agents can be used as necessary.

In particular, a water-miscible organic solvent is preferable since it prevent the formation of fine aggregates during the preliminarily dispersing treatment on the inorganic fine particles (silica), the water-soluble organic cationic polymer and the water-soluble polyvalent metal compound. The water-miscible organic solvent is used preferably in an amount of 0.1 to 20 wt %, more preferably 0.5 to 10 wt %, in the dispersion liquid.

The pH value at the preparation of the inorganic fine particle (vapor-phase-method silica) dispersion liquid can be changed widely depending on the type of the inorganic fine particles (vapor-phase-method silica), the type of the water-soluble organic cationic polymer, and various additives. In general, the pH value is preferably 1 to 8, more preferably 2 to 7. The above dispersion liquids can be used as a mixture of two or more thereof. It is possible to employ two or more of dispersing methods selected from the above dispersing methods.

The average primary particle diameter of the inorganic fine particles is preferably 30 nm or less, more preferably 20 nm or less, still more preferably 10 m or less, further more preferably 3 to 10 nm. From the viewpoint of imparting glossiness, the average primary particle diameter of the vapor-phase-method silica is preferably 30 nm or less, and the secondary particle diameter of the inorganic fine particles in the dispersion liquid after the dispersing treatment is preferably 200 nm or less, more preferably 150 nm or less, still more preferably 120 nm or less.

Particles of the vapor-phase-method silica easily adhere to one another via hydrogen bonds between silanol groups. Therefore, when the average primary particle diameter is 30 m or less, the vapor-phase-method silica can form a structure of high porosity to effectively improve ink absorptivity and the transparency and surface gloss of the ink-receiving layer. The vapor-phase-method silica may be used in the form of primary particles or may be used in the form of secondary particles after the formation of secondary particles.

### (Water-Soluble Organic Cationic Compound)

The vapor-phase-method silica is preferably subjected to a preliminary dispersing treatment prior to the dispersing treatment using the high-pressure dispersing machine. In the inorganic fine particle dispersion liquid of the invention, a water-soluble organic cationic compound is used as a dispersant (aggregation inhibitor).

The water-soluble organic cationic compound is not particularly limited, and preferably selected from water-soluble organic cationic compounds (including salts thereof) having a primary to tertiary amino group, having a quaternary ammonium base, or having a phosphonium base. The mordants described later are also included in preferable examples of the water-soluble organic cationic compound. The average molecular weight of the water-soluble organic cationic compound is preferably 50,000 or less, more preferably 20,000 or less. As another dispersant, a silane coupling agent can be used.

Among the above water-soluble organic cationic compounds, water-soluble organic cationic compounds each having a structural unit of a polydiallyl amine derivative are preferable. These are obtained by cyclizing condensation of diallyl amine compounds, and are commercially available as SHAROL DC902P (Dai-ichi Kogyo Seiyaku Co., Ltd.), JET FIX 110 (Satoda Kako), UNISENSE CP-101 to 103 (Senka), and PAS-H (Nitto Boseki Co., Ltd.).

The amount of the water-soluble organic cationic compound to be used is preferably 1 to 10 wt %, more preferably 1 to 5 wt %, based on the weight of the inorganic fine particles (for example, the silica fine particles). When the amount is increased, as described above, gelling performance after coating may be lowered depending on the type of the vapor-phase-method silica used.

The water-soluble organic cationic compound is preferably water-soluble or of aqueous emulsion type, and examples thereof include dicyan-based cationic resins represented by dicyandiamide-formalin polycondensates, polyamine-based cationic resins represented by dicyamide-diethylene triamine polycondensates, polycation-based cationic resins such as epichlorohydrin-dimethylamine addition polymers, dimethyl diallyl ammonium chloride-SO₂ copolymers, diallylamine salt-SO₂ copolymers, dimethyldiallyl ammonium chloride polymers, allyl amine salt polymers, quaternary salt polymers of dialkylaminoethyl (meth)acrylates, and acrylamide/diallyl amine salt copolymers. Among these organic cationic compounds, dimethyl diallyl ammonium chloride, monomethyl diallyl ammonium chloride, and polyamidine are preferable, and dimethyl diallyl ammonium chloride and monomethyl ammonium chloride are particularly preferable in respect of water resistance. Only one water-soluble organic cationic compound may be used, or two or more water-soluble organic cationic compounds may be used in combination.

The amount of the water-soluble organic cationic compound to be added to the ink-receiving layer is preferably 1 to 10 wt %, more preferably 1 to 5 wt %, based on the weight of the vapor-phase-method silica.

The water-soluble organic cationic compound may be added to the dispersing medium prior to the addition of the silica fine particles or may be added during pre-mixing or after completion of the dispersing treatment, but the water-soluble organic cationic compound is preferably added to the dispersing medium prior to the addition of the silica fine particles.

### (Water-Soluble Polyvalent Metal Compound)

The inorganic fine particle dispersion liquid of the invention comprises a water-soluble polyvalent metal compound.

The water-soluble polyvalent metal compound in the invention may be added to the dispersing medium or may be added during pre-mixing or after the completion of the dispersing treatment. The water-soluble polyvalent metal compound is preferably added to the dispersing medium prior to addition of the silica fine particles.

The water-soluble polyvalent metal compound used in the invention is preferably a trivalent or higher-valent metal compound. The metal compound may be, for example, a water-soluble salt of a metal selected from calcium, barium, manganese, copper, cobalt, nickel, aluminum, iron, zinc, zirconium, chromium, magnesium, tungsten and molybdenum.

Examples of such compounds include calcium acetate, calcium chloride, calcium formate, calcium sulfate, calcium butyrate, barium acetate, barium sulfate, barium phosphate, barium oxalate, barium naphthoresorcin carboxylate, barium butyrate, manganese chloride, manganese acetate, manganese formate.2H₂O, ammonium manganese sulfate.6H₂O, cupper(II) chloride, cupper(II) ammonium chloride.2H₂O, copper sulfate, copper(II) butyrate, copper oxalate, copper phthalate, copper citrate, copper gluconate, copper naphthenate, cobalt chloride, cobalt thiocyanate, cobalt sulfate, cobalt(II) acetate, cobalt napthenate, nickel sulfate-6H₂O, nickel chloride.6H₂O, nickel acetate.4H₂O, ammonium nickel sulfate.6H₂O, dinickel amidosulfate.4H₂O, nickel sulfaminate, nickel 2-ethyl hexanoate, aluminum sulfate, aluminum sulfite, aluminum thiosulfate, polyaluminum chloride, aluminum nitrate-9H₂O, aluminum chloride.6H₂O, aluminum acetate, aluminum lactate, basic aluminum thioglycolate, ferrous bromide, ferrous chloride, ferric chloride, ferrous sulfate, ferric sulfate, iron(III) nitrate, iron(III) lactate.3H₂O, iron(III) ammonium trioxalate.3H₂O, zinc bromide, zinc chloride, zinc nitrate.6H₂O, zinc sulfate, zinc acetate, zinc lactate, zirconyl acetate, zirconyl chloride, zirconyl oxide chloride.8H₂O, zirconyl hydroxychloride, chrome acetate, chrome sulfate, magnesium acetate, magnesium oxalate, magnesium sulfate, magnesium chloride.6H₂O, magnesium citrate.9H₂O, sodium phosphotungstate, tungsten sodium citrate, 12-tungustophosphoric acid.nH₂O, 12-tungstosilicic acid-26H₂O, molybdenum chloride, and 12-molybdophoshoric acid.nH₂O. Two or more water-soluble polyvalent metal compounds may be used in combination. In the invention, the water-soluble polyvalent metal compound has a solubility in water of 1 wt % or more at 20° C.

The water-soluble polyvalent metal compound is preferably a compound comprising aluminum or a metal (for example, zirconium, titanium) of group 4A of Periodic Table. The water-soluble polyvalent metal compound is particularly preferably a water-soluble aluminum compound. The water-soluble aluminum compound may be an inorganic aluminum salt, and examples thereof include aluminum chloride and hydrates thereof, aluminum sulfate and hydrates thereof, and aluminum alum. The water-soluble aluminum compound may also be a basic polyaluminum hydroxide compound, which is an inorganic aluminum-containing cationic polymer.

The basic polyaluminum hydroxide compound is a water-soluble polyaluminum hydroxide compound comprising a main component represented by the following formula 1, 2 or 3. Accordingly, the basic polyaluminum hydroxide compound stably comprises a basic polymeric polynuclear condensed ion such as [Al₆(OH)₁₅]³⁺, [Al₈(OH)₂₀]⁴⁺,[Al₁₃(OH)₃₄]⁵⁺ or [Al₂₁(OH)₆₀]³⁺.

[Al₂(OH)ₙCl₆₋ₙ]ₘ formula 1

[Al(OH)₃]AlCl₃ formula 2

Alₙ(OH)ₘCl₍₃ₙ₋ₘ₎0≦m≦3n formula 3

Such compounds are commercially available as a water treating agent under the name of polyaluminum chloride (PAC) from Taki Kagaku Co., Ltd., under the name of polyaluminum hydroxide (PAHO) from Asada Kagaku Co., Ltd., under the name of HAP-25 from Riken Green Co., Ltd., under the name of ALFINE 83 from Taimei Kagaku Co., Ltd., and also available from other manufactures, and compounds of various grades are easily available.

The water-soluble compound containing an element of group 4A of Periodic Table is more preferably a water-soluble compound containing titanium or zirconium. The water-soluble compound containing titanium may be, for example, titanium chloride or titanium sulfate. Examples of the zirconium-containing water-soluble compound include zirconyl acetate, zirconyl chloride, zirconyl oxychloride, zirconyl hydroxychloride, zirconyl nitrate, basic zirconyl carbonate, zirconyl hydroxide, zirconyl lactate, ammonium zirconyl carbonate, potassium zirconyl carbonate, zirconyl sulfate, and zirconyl fluoride compounds.

The water-soluble polyvalent metal compound described above is added preferably in a ratio of 0.1 to 10 wt %, more preferably 0.5 to 8 wt %, to the inorganic fine particles. The concentration of the inorganic fine particles in the dispersion liquid is generally about 10 to about 40 wt %, preferably 15 to 35 wt %.

The dispersing medium of the inorganic fine particle (for example, silica fine particle) dispersion liquid of the invention comprises water as the main component, and small amounts of other optional organic solvents (low-boiling solvent such as lower alcohol and ethyl acetate). When the dispersing medium comprises an organic solvent, the amount of the organic solvent is preferably 20 wt % or less, more preferably 10 wt % or less, based on the entire dispersing medium. Preliminary mixing (preliminary dispersing treatment) can be carried out by usual propeller stirring, turbine stirring, homomixer stirring etc.

In order to achieve a higher concentration of silica in the dispersion liquid, a method of adding silica stepwise can be used.

The liquid temperature in primary dispersing (premixing or preliminary dispersing) in the invention is not particularly specified, and is preferably 30° C. or less, more preferably 25° C. or less. At such a temperature, silica slurry can be prepared stably. In an embodiment, the dispersing medium prior to the addition of the silica fine particles is set at a temperature of 20° C. or less. In another embodiment, the liquid is cooled to 20° C. or less during premixing.

The temperature of the silica slurry upon introduction into the dispersing machine is preferably 20° C. or less, more preferably 15° C. or less. With such a temperature of the silica slurry, a further stabilized dispersion liquid can be obtained.

In the invention, propeller stirring, turbine stirring, homomixer stirring or sonication stirring can be used in primary dispersing (premixing, preliminary dispersion). In secondary dispersing, a high-pressure dispersing machine (e.g., ALTIMIZER manufactured by Sugino Machine Incorporated) in a liquid to liquid head-on collision system such as described above may be used.

The coating operation may be conducted at least 5 hours after (preferably at least 8 hours after) at least one of the preparation of the inorganic fine particle dispersion liquid of the invention (silica dispersion liquid) and the preparation of the ink-receiving layer coating liquid (silica coating liquid), in view of the stabilization of the coating surface state. The upper limit of the time between the preparation of the inorganic fine particle dispersion liquid and the coating is not limited, and may be several days to several tens days. The temperature of the dispersion liquid or the ink-receiving layer coating liquid during the period between the preparation and the coating may be about 10° C. to about 40° C., preferably about 15° C. to about 35° C. During the period, the dispersion liquid or ink-receiving layer coating liquid may be mildly stirred to prevent the precipitation of the fine particles.

In the invention, it is preferable to conduct a heat treatment of 45° C. or less on the inorganic fine particle dispersion liquid after the completion of the dispersing of the inorganic fine particles but before coating, in view of the stability of the coating liquid.

In particular, it is preferable to conduct a heat treatment on the inorganic fine particle dispersion liquid (silica dispersion liquid) in which the dispersion liquid is maintained in the range of 30 to 48° C. (more preferably 40 to 45° C.) for about 120 minutes or more (there is no upper limit, preferably not shorter than about 1 hour but not longer than about 24 hours), before the preparation of the coating liquid. It is particularly preferable to secure a period of at least 5 hours between the preparation of the dispersion liquid and coating, and also to conduct the above heat treatment.

The inkjet recording medium of the invention is produced by applying a coating liquid onto a support such as paper, a polyolefin resin-laminated paper, or a plastic resin film. The coating liquid may be the inorganic fine particle dispersion liquid itself produced as described above, or an ink-receiving layer coating liquid prepared by mixing the inorganic fine particle dispersion liquid with a hydrophilic binder such as polyvinyl alcohol, a crosslinking agent, a surfactant, a water-dispersible cationic resin etc. The concentration of the inorganic fine particles in the coating liquid may be suitably about 5 to about 25 wt %, preferably 8 to 20 wt %. In the invention, the amount of the inorganic fine particles contained in the ink-receiving layer is preferably in the range of 5 to 30 g/m².

It is preferable to dissolve the water-soluble resin, the surfactant, and the water-soluble organic solvent having a boiling point of 150° C. or more in an aqueous solution (aqueous medium) in the preparation of the inkjet recording medium of the invention.

### (Water-Soluble Resin)

The ink-receiving layer of the inkjet recording medium of the invention contains a water-soluble resin. Examples of the water-soluble resin include polyvinyl alcohol resins having hydroxyl groups as hydrophilic structural units [e.g., polyvinyl alcohol (PVA), acetoacetyl-modified polyvinyl alcohol, cation-modified polyvinyl alcohol, anion-modified polyvinyl alcohol, silanol-modified polyvinyl alcohol, polyvinyl acetal etc.], cellulose-based resins [e.g., methyl cellulose (MC), ethyl cellulose (EC), hydroxyethyl cellulose (HEC), carboxymethyl cellulose (CMC), hydroxypropyl cellulose (HPC), hydroxyethyl methyl cellulose, hydroxypropyl methyl cellulose], chitins, chitosans, starch, resins containing ether bonds [e.g., polyethylene oxide (PEO), polypropylene oxide (PPO), polyethylene glycol (PEG), polyvinyl ether (PVE)], carbamoyl-containing resins [e.g., polyacrylamide (PAAM), polyvinyl pyrrolidone (PVP), polyacrylic acid hydrazide], and resins containing carboxyl groups as dissociable groups (e.g., polyacrylates, maleic resins, alginates and gelatins).

Although the water-soluble resin is not particularly limited, the type of the water-soluble resin to be combined with the vapor-phase-method silica is important from the viewpoint of the transparency and coatability of the layer, and polyvinyl alcohol resins are preferable. Examples of the polyvinyl alcohol resins include the resins described in JP-B No. 4-52786, JP-B No. 5-67432, JP-B No. 7-29479, JP Patent No. 2537827, JP-B No. 7-57553, JP Patent No. 2502998, JP Patent No. 3053231, JP-A No. 63-176173, JP Patent No. 2604367, JP-A No. 7-276787, JP-A No. 9-207425, JP-A No. 11-58941, JP-A No. 2000-135858, JP-A No. 2001-205924, JP-A No. 2001-287444, JP-A No. 62-278080, JP-A No. 9-39373, JP Patent No. 2750433, JP-A No. 2000-158801, JP-A No. 2001-213045, JP-A No. 2001-328345, JP-A No. 8-324105, JP-A No. 11-348417 etc. Examples of water-soluble resins other than polyvinyl alcohol resins include compounds described in [0011] to [0014] in JP-A No. 11-165461, etc. Only one water-soluble resin may be used, or two or more water-soluble resins may be used simultaneously.

Polyvinyl alcohol resins have hydroxyl groups in their structure units. Since the hydroxyl groups and the surface silanol groups on the vapor-phase-method silica form hydrogen bonds, a three-dimensional network structure containing secondary particles of the silica fine particles as chain units is easily formed. The ink-receiving layer of the porous structure having high void ratio and sufficient strength can be formed owing to the formation of the three-dimensional network structure. Because the ink-receiving layer having porous structure rapidly absorbs ink by capillary phenomenon, dots with excellent roundness can be formed without ink bleeding.

Only one water-soluble resin may be used, or two or more water-soluble resins may be used simultaneously. The content of the water-soluble resin in the ink-receiving layer is preferably 9 to 40% by weight, and more preferably 12 to 33% by weight, based on the total solid weight of the ink-receiving layer. In an embodiment, one or more other water-soluble resins other than polyvinyl alcohol resins may be used together with the polyvinyl alcohol resin, and the proportion of polyvinyl alcohol resin to the all the water-soluble resins is preferably 50% by weight or more, more preferably 70% by weight or more.

The water-soluble resin may be, for example, a polyvinyl alcohol, a polyvinyl pyrrolidone, a cellulose such as carboxymethyl cellulose, or a gelatin. The water-soluble resin is preferably polyvinyl alcohol. The polyvinyl alcohol is preferably saponified completely or partially, and has a saponification degree of preferably 80% or higher. The average polymerization degree of the polyvinyl alcohol is preferably 500 to 5000. The cation-modified polyvinyl alcohol may be a polyvinyl alcohol whose main chain or side chain has a primary amino group, a secondary amino group, a tertiary amino group, or a quaternary ammonium group, such as the cation-modified polyvinyl alcohols described in JP-A No. 61-10483.

### <Content Ratio of Inorganic Particles to Water-Soluble Resin>

The content ratio [PB ratio (x/y)] of the weight (x) of the vapor-phase-method silica to the weight (y) of the water-soluble resin greatly affects the structure and strength of the ink-receiving layer. A higher PB ratio increases the void ratio, the pore volume, and the surface area (per unit weight), but tends to decrease the density and strength. The ink-receiving layer of the invention preferably has a PB ratio in the range of 1.5 to 10 in view of preventing the reduction of film strength and cracking at drying caused by increase in PB ratio and also preventing the reduction of the void ratio accompanied by the reduction of the ink absorbing property caused by the increased possibility of clogging of the pores with the resin at a lower PB ratio. The amount of the water-soluble resin to be added is preferably 5 to 40% by weight, more preferably 10 to 25% by weight, based on the weight of the inorganic fine particles.

Since a recording sheet may be stressed when the sheet passes the transportation system of an inkjet printer, the ink-receiving layer should have sufficient film strength. The strength of the ink-receiving layer is required also from the viewpoint of preventing the cracking and peeling of the ink-receiving layer upon being cut in sheets. Therefore, the PB ratio (x/y) is preferably 5 or lower considering the above requirements. The PB ratio is preferably 2 or higher in view of securing the high-speed ink absorbing property in the inkjet printer.

For instance, when a coating liquid in which vapor-phase-method silica having an average primary particle diameter of 20 nm or less and a water-soluble resin in a PB ratio in the range of 2 to 5 are completely dispersed in an aqueous solution is coated on a support and then dried, a three-dimensional network structure containing the secondary particles of the silica fine particles as chain units is formed. As a result, a translucent porous membrane can be easily formed in which the average pore size is 30 nm or less; the void ratio is 50 to 80%; the pore ratio volume is 0.5 ml/g or more; and the specific surface area is 100 m²/g or greater.

### (Crosslinking Agent)

The ink-receiving layer of the invention may comprise a crosslinking agent. When the ink-receiving layer comprises a crosslinking agent capable of crosslinking the water-soluble resin, the ink-receiving layer can be a porous layer cured by the crosslinking reaction between the crosslinking agent and the water-soluble resin.

The crosslinking agent for crosslinking the water-soluble resin (especially, a polyvinyl alcohol resin) is preferably a boron compound. Examples of the boron compound include borax, boric acid, boric acid salts (e.g., orthoboric acid salt, InBO₃, ScBO₃, YBO₃, LaBO₃, Mg₃(BO₃)₂, and CO₃(BO₃)₂), diboric acid salts (e.g., Mg₂B₂O₅ and CO₂B₂O₅), metaboric acid salts (e.g., LiBO₂, Ca(BO₂)₂, NaBO₂, and KBO₂), tetraboric acid salts (e.g., Na₂B₄O₇.10H₂O) and pentaboric acid salts (e.g., KB₅O₈.4H₂O, Ca₂B₆O₁₁.7H₂O, and CsB₅O₅). Borax, boric acid, and boric acid salts are preferable among them since they cause rapid crosslinking reaction. Boric acid is particularly preferable.

Examples of hardeners include: aldehyde compounds such as formaldehyde and glutaraldehyde; ketone compounds such as diacetyl and chloropentanedione; compounds having reactive halogen, such as bis(2-chloroethylurea)-2-hydroxy 4,6-dichloro-1,3,5-triazine and the compounds described in U.S. Pat. No. 3,288,775; compounds having reactive olefins, such as divinyl sulfone and the compounds described in U.S. Pat. No. 3,635,718; N-methylol compounds, such as described in U.S. Pat. No. 2,732,316; isocyanate compounds, such as described in U.S. Pat. No. 3,103,437; aziridine compounds, such as described in U.S. Pat. Nos. 3,017,280 and 2,983,611; carbodiimide compounds, such as described in U.S. Pat. No. 3,100,704; epoxy compounds, such as described in U.S. Pat. No. 3,091,537; halogen carboxy aldehydes such as mucochloric acid; dioxane derivatives such as dihydroxy dioxane; and inorganic hardeners such as chrome alum, zirconyl sulfate, boric acid, and borates. Only one hardener may be used, or two or more hardeners may be used in combination.

The crosslinking agent may be a compound other than boron compounds. Examples thereof include: aldehyde compounds such as formaldehyde, glyoxal and glutalaldehyde; ketone compounds such as diacetyl and cyclopentanedione; activated halogen compounds such as bis(2-chloroethylurea)-2-hydroxy 4,6-dichloro-1,3,5-triazine, and 2,4-dichloro-6-S-triazine sodium salt; activated vinyl compounds such as divinyl sulfonic acid, 1,3-vinylsulfonyl-2-propanol, N,N′-ethylene bis(vinylsulfonyl acetamido), 1,3,5-triacryloyl-hexahydro-5-triazine; N-methylol compound such as dimethylol urea and methyloldimethylhydantoin; melamine resins (e.g., methylol melamine and alkylated methylol melamine); epoxy resins; isocyanate compounds such as 1,6-hexamethylene diisocyanate; aziridine compounds described in U.S. Pat. Nos. 3,017,280 and 2,983,611; carboxylmide compounds described in U.S. Pat. No. 3,100,704; epoxy-based compounds such as glycerol triglycidyl ether; ethyleneimino compounds such as 1,6-hexamethylene-N, N′-bisethylene urea; halogenated carboxy aldehyde compounds such as mucochloric acid and mucophenoxychloric acid; dioxane compounds such as 2,3-dihydroxy dioxane; metal-containing compounds such as titanium lactate, aluminum sulfate, chrome alum, potassium alum, zirconyl acetate and chrome acetate, polyamine compounds such as tetraethylenepentamine, hydrazide compounds such as adipic dihydrazide, low molecular compounds each containing at least two oxazoline groups, and polymers each containing at least two oxazoline groups. Only one crosslinking agent may be used, or two or more crosslinking agents may be used in combination.

The crosslinking agent may be added to the coating liquid for forming the ink-receiving layer and/or to the coating liquid for forming the layer adjacent to the ink-receiving layer upon application of the coating liquid for forming the ink-receiving layer (occasionally referred to as “ink-receiving layer coating solution hereinafter). In an embodiment, a coating liquid including the crosslinking agent is coated on the support, and then the ink-receiving layer coating liquid is coated thereon, whereby the crosslinking agent is supplied to the ink-receiving layer. In another embodiment, the ink-receiving layer coating liquid free of crosslinking agent is coated and dried, and then a crosslinking agent solution is overcoated thereon, whereby the crosslinking agent is supplied to the ink-receiving layer.

For instance, the crosslinking agent may be provided in the following manner. In the following explanation, a boron compound is used as an example of the crosslinking agent. In this example, the ink-receiving layer is assumed to be formed by coating a coating liquid A for an ink-receiving layer, followed by crosslinking to cure the ink-receiving layer. The ink-receiving layer can be cured through crosslinking when a basic solution (solution B) having pH of 7.1 or higher is applied to the coated layer (ink-receiving layer). The solution B may be applied to the coated layer (1) simultaneously with coating of the coating liquid A or (2) before the coated layer (the layer of coating liquid A) exhibits a decreasing rate of drying during drying of the coated layer. The boron compound as the crosslinking agent may be contained either in the coating liquid A or in the solution B, or may be contained in both the coating liquid A and the solution B. When the ink-receiving layer comprises two or more layers, two or more coating liquids may be coated simultaneously (multilayer coating), and the basic solution (solution B) may be applied thereon.

The amount of the crosslinking agent to be used is preferably 0.01 to 50% by weight, more preferably 5 to 40% by weight, based on the weight of the water-soluble resin in the image-receiving layer.

Other inorganic fine particles can also be used in combination with the vapor-phase-method silica. Examples of such other inorganic fine particles include other silica fine particles, colloidal silica, titanium dioxide, barium sulfate, calcium silicate, zeolite, kaolinite, halloysite, mica, talc, calcium carbonate, magnesium carbonate, calcium sulfate, zinc oxide, zinc hydroxide, alumina, aluminum silicate, calcium silicate, magnesium silicate, zirconium oxide, zirconium hydroxide, cerium oxide, lanthanum oxide and yttrium oxide. These fine particles may be contained in the state of primary particles or secondary particles, and their average primary particle diameter is preferably 20 μm or less, more preferably 200 nm or less.

### (Water-Dispersible Cationic Resin)

Examples of the water-dispersible cationic resin include urethane resins, acrylic resins, styryl resins, and butadiene resins. The water-dispersible cationic resin is preferably a urethane resin that is a cation-modified self-emulsifiable polymer, and its glass transition temperature is preferably lower than 50° C.

The term “self-emulsifiable polymer” used herein refers to a polymer compound which forms a stable emulsion by itself in an aqueous dispersing medium in the absence of emulsifier and surfactant or in the presence of very little amount of emulsifier and/or surfactant. Quantitatively, the cation-modified self-emulsifiable polymer is capable of forming a stable emulsion in an aqueous dispersing medium at room temperature (25° C.) at a concentration of 0.5 wt % or more (preferably 1 wt % or more, more preferably 3 wt % or more) based on the weight of the aqueous dispersing medium.

Specific examples of the “cation-modified self-emulsifiable polymer” in the invention include polymer compounds having cationic groups (e.g., primary to tertiary amino groups and quaternary ammonium groups) obtained by polyaddition or polycondensation.

Examples of vinyl polymers as useful examples of the water-dispersible cationic polymer include polymers obtained by polymerizing the following vinyl monomers: acrylates or methacrylates (whose ester group is an optionally substituted alkyl group or aryl group, for example, a methyl group, an ethyl group, an n-propyl group, an isopropyl group, an n-butyl group, a sec-butyl group, a tert-butyl group, a hexyl group, a 2-ethylhexyl group, a tert-octyl group, a 2-chloroethyl group, a cyanoethyl group, a 2-acetoxyethyl group, a tetrahydrofurfuryl group, a 5-hydroxypentyl group, a cyclohexyl group, a benzyl group, a hydroxyethyl group, a 3-methoxybutyl group, a 2-(2-methoxyethoxy)ethyl group, a 2,2,2-tetrafluoroethyl group, a 1H,1H,2H,2H-perfluorodecyl group, a phenyl group, a 2,4,5-tetramethylphenyl group, a 4-chlorophenyl group etc.);

vinyl esters, specifically, optionally substituted vinyl esters of aliphatic carboxylic acids (for example, vinyl acetate, vinyl propionate, vinyl butyrate, vinyl isobutyrate, vinyl caproate, vinyl chloroacetate, etc.), optionally substituted vinyl esters of aromatic carboxylic acids (for example, vinyl benzoate, vinyl 4-methylbenzoate, vinyl salicylate etc.);

acrylamides, specifically, acrylamide, N-monosubstituted acrylamide, N-disubstituted acrylamide (whose substituent may be selected from optionally substituted alkyl groups, optionally substituted aryl groups and optionally substituted silyl groups, such as a methyl group, an n-propyl group, an isopropyl group, an n-butyl group, a tert-butyl group, a tert-octyl group, a cyclohexyl group, a benzyl group, a hydroxymethyl group, an alkoxymethyl group, a phenyl group, a 2,4,5-tetramethylphenyl group, a 4-chlorophenyl group, a trimethylsilyl group etc.);

methacrylamides, specifically, methacrylamide, N-monosubstituted methacrylamide, N-disubstituted methacrylamide (whose substituent may be selected from optionally substituted alkyl groups, optionally substituted aryl groups and optionally substituted silyl groups, such as a methyl group, an n-propyl group, an isopropyl group, an n-butyl group, a tert-butyl group, a tert-octyl group, a cyclohexyl group, a benzyl group, a hydroxymethyl group, an alkoxymethyl group, a phenyl group, a 2,4,5-tetramethylphenyl group, a 4-chlorophenyl group, a trimethylsilyl group etc.); and

olefins (for example, ethylene, propylene, 1-pentene, vinyl chloride, vinylidene chloride, isoprene, chloroprene, butadiene etc.), strenes (for example, styrene, methyl styrene, isopropyl styrene, methoxy styrene, acetoxy styrene, chlorostyrene etc.), vinyl ethers (for example, methyl vinyl ether, butyl vinyl ether, hexyl vinyl ether, methoxyethyl vinyl ether etc.).

Examples of other vinyl monomers include crotonic esters, itaconic esters, maleic diesters, fumaric diesters, methyl vinyl ketone, phenyl vinyl ketone, methoxy ethyl vinyl ketone, N-vinyl oxazolidone, N-vinyl pyrrolidone, methylene malone nitrile, diphenyl-2-acryloyloxyethyl phosphate, diphenyl-2-methacryloyloxyethyl phosphate, dibutyl-2-acryloyloxyethyl phosphate, and dioctyl-2-methacryloyloxyethyl phosphate.

Examples of the monomer containing a cationic group include monomers containing tertiary amino groups, such as dialkyl aminoethyl methacrylate and dialkyl aminoethyl acrylate.

Examples of the polyurethane applicable to the polymer containing a cationic group include a polyurethane synthesized by polyaddition reaction of a combinations of any of the following diol compounds and any of the following diisocyanate compounds.

Examples of diol compounds include ethylene glycol, 1,2-propane diol, 1,3-propane diol, 1,2-butane diol, 1,3-butane diol, 2,3-butane diol, 2,2-dimethyl-1,3-propane diol, 1,2-pentane diol, 1,4-pentane diol, 1,5-pentane diol, 2,4-pentane diol, 3,3-dimethyl-1,2-butane diol, 2-ethyl-2-methyl-1,3-propane diol, 1,2-hexane diol, 1,5-hexane diol, 1,6-hexane diol, 2,5-hexane diol, 2-methyl-2,4-pentane diol, 2,2-diethyl-1,3-propane diol, 2,4-dimethyl-2,4-pentane diol, 1,7-heptane diol, 2-methyl-2-propyl-1,3-propane diol, 2,5-dimethyl-2,5-hexane diol, 2-ethyl-1,3-hexane diol, 1,2-octane diol, 1,8-octane diol, 2,2,4-trimethyl-1,3-pentane diol, 1,4-cyclohexane dimethanol, hydroquinone, diethylene glycol, triethylene glycol, dipropylene glycol, tripropylene glycol, polyethylene glycol (average molecular weight=200, 300, 400, 600, 1000, 1500, or 4000), polypropylene glycol (average molecular weight=200, 400, or 1000), polyester polyol, 4,4′-dihydroxy-diphenyl-2,2-propane, and 4,4′-dihydroxyphenyl sulfone.

Examples of diisocyanate compounds include methylene diisocyanate, ethylene diisocyanate, isophorone diisocyanate, hexamethylene diisocyanate, 1,4-cyclohexane diisocyanate, 2,4-toluene diisocyanate, 2,6-toluene diisocyanate, 1,3-xylylene diisocyanate, 1,5-naphthalene diisocyanate, m-phenylene diisocyanate, p-phenylene diisocyanate, 3,3′-dimethyl-4,4′-diphenyl methane diisocyanate, 3,3′-dimethylbiphenylene diisocyanate, 4,4′-biphenylene diisocyanate, dicyclohexyl methane diisocyanate, and methylene bis(4-cyclohexyl isocyanate).

In the polyurethane containing a cationic group, the cationic group may be a primary, secondary or tertiary amine or a quaternary ammonium salt. The self-emulsifiable polymer usable in the aqueous dispersion in the invention is preferably a urethane resin having a cationic group which may be a tertiary amine or a quaternary ammonium salt.

The polyurethane containing a cationic group is obtained, for example by using a diol (such as described above) to which a cationic group is introduced for the synthesis of the polyurethane. The polyurethane containing a quaternary ammonium salt may be synthesized by converting a polyurethane containing a tertiary amino group to a quaternary ammonium salt by using a quaternizing agent.

Only one diol compound may be used for the synthesis of the polyurethane, or two or more diol compounds in an arbitrary ratio may be used for the synthesis of the polyurethane for various purposes (for example, regulation of the glass transition temperature (Tg) of the polymer, improvement of the solubility of the polymer, imparting compatibility with a binder, improvement of the stability of the dispersion, etc.). Only one diisocyanate compound may be used for the synthesis of the polyurethane, or two or more diisocyanate compounds in an arbitrary ratio may be used for the synthesis of the polyurethane for various purposes (for example, regulation of the glass transition temperature (Tg) of the polymer, improvement of the solubility of the polymer, imparting compatibility with a binder, improvement of the stability of the dispersion, etc.)

### (Other Components)

### Mordant

In a preferable embodiment, the ink-receiving layer further comprises a mordant (such as described below) so as to further improve image bleeding over time and water resistance. Examples of the mordant include an organic mordant such as a cationic polymer (a cationic mordant) and an inorganic mordant such as a water-soluble metal compound. The cationic mordant is preferably a polymer mordant having a primary, secondary or tertiary amino group, or a quaternary ammonium group as a cationic functional group. A cationic non-polymer mordant can be also used.

The polymer mordant is preferably a homopolymer of a monomer (mordant monomer) having a group selected from a primary amino group, a secondary amino group or a tertiary amino group, salts of primary to tertiary amino groups, and a quaternary ammonium group, or a copolymer or a condensation polymer of such a mordant monomer and one or more other monomers (non-mordant monomers). The polymer mordant can be used in the form of a water-soluble polymer or in the form of water dispersible latex particles.

Examples of the mordant monomer include trimethyl-p-vinylbenzyl ammonium chloride, trimethyl-m-vinylbenzyl ammonium chloride, triethyl-p-vinylbenzyl ammonium chloride, triethyl-m-vinylbenzyl ammonium chloride, N,N-dimethyl-N-ethyl-N-p-vinylbenzyl ammonium chloride, N,N-diethyl-N-methyl-N-p-vinylbenzyl ammonium chloride, N,N-dimethyl-N-n-propyl-N-p-vinylbenzyl ammonium chloride, N,N-dimethyl-N-n-octyl-N-p-vinylbenzyl ammonium chloride, N,N-dimethyl-N-benzyl-N-p-vinylbenzyl ammonium chloride, N,N-diethyl-N-benzyl-N-p-vinylbenzyl ammonium chloride, N,N-dimethyl-N-(4-methyl)benzyl-N-p-vinylbenzyl ammonium chloride, N,N-dimethyl-N-phenyl-N-p-vinylbenzyl ammonium chloride;

trimethyl-p-vinylbenzyl ammonium bromide, trimethyl-m-vinylbenzyl ammonium bromide, trimethyl p-vinylbenzyl ammonium sulfonate, trimethyl-m-vinylbenzyl ammonium sulfonate, trimethyl-p-vinylbenzyl ammonium acetate, trimethyl-m-vinylbenzyl ammonium acetate, N,N,N-triethyl-N-2-(4-vinylphenyl)ethyl ammonium chloride, N,N,N-triethyl-N-2-(3-vinylphenyl)ethyl ammonium chloride, N,N-diethyl-N-methyl-N-2-(4-vinylphenyl)ethyl ammonium chloride, N,N-diethyl-N-methyl-N-2-(4-vinylphenyl)ethyl ammonium acetate;

quaternized products of N,N-dimethylaminoethyl (meth)acrylate, N,N-diethylaminoethyl (meth)acrylate, N,N-dimethylaminopropyl (meth)acrylate, N,N-diethylaminopropyl (meth)acrylate, N,N-dimethylaminoethyl (meth)acrylamide, N,N-diethylaminoethyl (meth)acrylamide, N,N-dimethylaminopropyl (meth)acrylamide, and N,N-diethylaminopropyl (meth)acrylamide (the quaternized products being formed by using methyl chloride, ethyl chloride, methyl bromide, ethyl bromide, methyl iodide or ethyl iodide), and sulfonates, alkyl sulfonates, acetates and alkyl carboxylates respectively obtained by substituting the anions of the above quaternized products.

Specific examples of the mordant monomer include monomethyldiallyl ammonium chloride, trimethyl-2-(methacryloyloxy)ethyl ammonium chloride, triethyl-2-(methacryloyloxy)ethyl ammonium chloride, trimethyl-2-(acryloyloxy)ethyl ammonium chloride, triethyl-2-(acryloyloxy)ethyl ammonium chloride, trimethyl-3-(methacryloyloxy)propyl ammonium chloride, triethyl-3-(methacryloyloxy)propyl ammonium chloride, trimethyl-2-(methacryloylamino)ethyl ammonium chloride, triethyl-2-(methacryloylamino)ethyl ammonium chloride, trimethyl-2-(acryloylamino)ethyl ammonium chloride, triethyl-2-(acryloylamino)ethyl ammonium chloride, trimethyl-3-(methacryloylamino)propyl ammonium chloride, triethyl-3-(methacryloylamino)propyl ammonium chloride, trimethyl-3-(acryloylamino)propyl ammonium chloride, triethyl-3-(acryloylamino)propyl ammonium chloride; N,N-dimethyl-N-ethyl-2-(methacryloyloxy)ethyl ammonium chloride,

N,N-diethyl-N-methyl-2-(methacryloyloxy)ethyl ammonium chloride, N,N-dimethyl-N-methyl-3-(acryloylamino)propyl ammonium chloride, trimethyl-2-(methacryloyloxy)ethyl ammonium bromide, trimethyl-3-(acryloylamino)propyl ammonium bromide, trimethyl-2-(methacryloyloxy)ethyl ammonium sulfonate, and trimethyl-3-(acryloylamino)propyl ammonium acetate. Examples of other monomers that can be copolymerized with the mordant monomer include N-vinylimidazole and N-vinyl-2-methylimidazole. The polymer containing vinylamine units can be obtained also by the hydrolysis of a polymer generated by the polymerization of N-vinylacetamide, N-vinylformamide or the like as the polymerization unit.

The non-mordant monomer refers to a monomer which does not contain a basic or cationic part (such as a primary, secondary or tertiary amino group or a salt of a primary, secondary or tertiary amino group), and which shows no or substantially weak interaction with the dye contained in inkjet ink. Examples of the non-mordant monomers include: alkyl (meth)acrylate esters; cycloalkyl (meth)acrylate esters such as cyclohexyl (meth)acrylate; aryl (meth)acrylate esters such as phenyl (meth)acrylate; aralkyl esters such as benzyl (meth)acrylate; aromatic vinyls such as styrene, vinyl toluene and α-methyl styrene; vinylesters such as vinyl acetate, vinyl propionate and vinyl versatate; allyl esters such as allyl acetate; halogen-containing monomers such as vinylidene chloride and vinyl chloride; vinyl cyanide such as (meth)acrylonitrile; olefins such as ethylene and propylene.

The alkyl portion of each of the alkyl (meth)acrylate esters described above preferably have 1 to 18 carbon atoms. Examples thereof include methyl (meth)acrylate, ethyl (meth)acrylate, propyl (meth)acrylate, isopropyl (meth)acrylate, n-butyl (meth)acrylate, isobutyl (meth)acrylate, t-butyl (meth)acrylate, hexyl (meth)acrylate, octyl (meth)acrylate, 2-ethylhexyl (meth)acrylate, lauryl (meth)acrylate and stearyl (meth)acrylate. Methyl acrylate, ethyl acrylate, methyl methacrylate, ethyl methacrylate and hydroxyethyl methacrylate are preferable among them. Only one non-mordant monomer may be used, or two or more non-mordant monomers may be used in combination.

Preferable examples of the polymer mordant include dicyan-based cationic resins represented by polydiallyldimethyl ammonium chloride, polymethacryloyloxyethyl-p-hydroxyethyldimethyl ammonium chloride, polyethylene imine, polyamide-polyamine resin, cationic starch, dicyandiamide-formalin condensates, dimethyl-2-hydroxypropyl ammonium salt polymers, polyamidine, polyvinylamine, and dicyandiamide-formalin polycondensates, polyamine-based cationic resins represented by dicyanamide-diethylene triamine polycondensates, epichlorohydrin-dimethylamine addition polymers, dimethyldiallyl ammonium chloride-SO₂ copolymers and diallylamine salt-SO₂ copolymers.

Specific examples of the polymer mordant include the polymer mordants described in JP-A No. 48-28325, JP-A No. 54-74430, JP-A No. 54-124726, JP-A No. 55-22766, JP-A No. 55-142339, JP-A No. 60-23850, JP-A No. 60-23851, JP-A No. 60-23852, JP-A No. 60-23853, JP-A No. 60-57836, JP-A No. 60-60643, JP-A No. 60-118834, JP-A No. 60-122940, JP-A No. 60-122941, JP-A No. 60-122942, JP-A No. 60-235134, JP-A No. 1-161236, U.S. Pat. No. 2,484,430, U.S. Pat. No. 2,548,564, U.S. Pat. No. 3,148,061, U.S. Pat. No. 3,309,690, U.S. Pat. No. 4,115,124, U.S. Pat. No. 4,124,386, U.S. Pat. No. 4,193,800, U.S. Pat. No. 4,273,853, U.S. Pat. No. 4,282,305, U.S. Pat. No. 4,450,224, JP-A No. 1-161236, JP-A No. 10-81064, JP-A No. 10-119423, JP-A No. 10-157277, JP-A No. 10-217601, JP-A No. 11-348409, JP-A No. 2001-138621, JP-A No. 2000-43401, JP-A No. 2000-211235, JP-A No. 2000-309157, JP-A No. 2001-96897, JP-A No. 2001-138627, JP-A No. 11-91242, JP-A No. 8-2087, JP-A No. 8-2090, JP-A No. 8-2091, JP-A No. 8-2093, JP-A No. 8-174992, JP-A No. 11-1192777 and JP-A No. 2001-301314.

Also, the inorganic mordant may be a multivalent water-soluble metal salt or a hydrophobic metal salt compound. Examples thereof include salts and complexes of metals selected from magnesium, aluminum, calcium, scandium, titanium, vanadium, manganese, iron, nickel, copper, zinc, gallium, germanium, strontium, yttrium, zirconium, molybdenum, indium, barium, lanthanum, cerium, praseodymium, neodymium, samarium, europium, gadolinium, dysprosium, erbium, ytterbium, hafnium, tungsten and bismuth.

Specific examples of the inorganic mordant include calcium acetate, calcium chloride, calcium formate, calcium sulfate, barium acetate, barium sulfate, barium phosphate, manganese chloride, manganese acetate, manganese formate dihydrate, ammonium manganese sulfate hexahydrate, cupric chloride, ammonium chloride copper (II) dihydrate, copper sulfate, cobalt chloride, cobalt thiocyanate, cobalt sulfate, nickel sulfate hexahydrate, nickel chloride hexahydrate, nickel acetate tetrahydrate, ammonium nickel sulfate hexahydrate, nickel amidosulfate tetrahydrate, aluminum sulfate, aluminum alum, basic poly aluminum hydroxide, aluminum sulfite, aluminum thiosulfate, aluminum polychloride, aluminum nitrate nonahydrate, aluminum chloride hexahydrate, ferrous bromide, ferrous chloride, ferric chloride, ferrous sulfate, ferric sulfate, zinc phenolsulfonate, zinc bromide, zinc chloride, zinc nitrate hexahydrate, zinc sulfate, titanium tetrachloride, tetra isopropyl titanate, titanium acetylacetonate, titanium lactate, zirconyl acetylacetonate, zirconyl acetate, zirconyl sulfate, ammonium zirconyl carbonate, zirconyl stearate, zirconyl octylate, zircony nitrate, zirconyl oxychloride, zirconyl hydroxychloride, chromium acetate, chromic sulfate, magnesium sulfate, magnesium chloride hexahydrate, magnesium citrate nonahydrate, phosphorus sodium tungstate, tungsten sodium citrate, 12 tungstophosphate n-hydrate, 12 tungstosilicate 26 hydrate, molybdenum chloride, 12 molybdophosphate n-hydrate, gallium nitrate, manganese acetate, germanium nitrate, strontium nitrate, yttrium acetate, yttrium chloride, yttrium nitrate, indium nitrate, lanthanum nitrate, lanthanum chloride, lanthanum acetate, lanthanum benzoate, cerous chloride, cerium sulfate, cerium octylate, praseodymium nitrate, neodymium nitrate, samarium nitrate, europium nitrate, gadolinium nitrate, dysprosium nitrate, erbium nitrate, ytterbium nitrate, hafnium chloride, and bismuth nitrate. Among them, aluminum-containing compounds, titanium-containing compounds, zirconium-containing compounds, and metal compounds (salts or complexes) of metals of Group IIIB of Periodic Table are preferable.

When such mordants are added to the ink-receiving layer, their total amount is preferably 0.01 to 5 g/m².

### —Other Components —

If necessary, the inkjet recording sheet of the invention may further comprise various known additives such as an acid, a UV absorber, an antioxidant, a fluorescent brightener, a monomer, a polymerization initiator, a polymerization inhibitor, a bleed inhibitor, a preservative, a viscosity stabilizer, a defoaming agent, a surfactant, an antistatic agent, a matting agent, a curling inhibitor and a water-resistance imparting agent.

The ink-receiving layer according to the invention may comprise an acid. The yellowing resistance of the white background can be improved by such an addition of an acid as to set the pH value of the surface of the ink-receiving layer in the range of 3 to 8, preferably 3.5 to 7.5. The surface pH can be measured by method A (coating method) for measurement of surface pH specified by Japan Technical Association of the Pulp and Paper Industry (J. TAPPI). For example, a paper pH measurement set “type MPC” (KYORITSU CHEMICAL-CHECK Lab., Corp.) corresponding to the method A can be used for the measurement.

Examples of the acid include formic acid, acetic acid, glycolic acid, oxalic acid, propionic acid, malonic acid, succinic acid, adipic acid, maleic acid, malic acid, tartaric acid, citric acid, benzoic acid, phthalic acid, isophthalic acid, glutaric acid, gluconic acid, lactic acid, aspartic acid, glutamic acid, salicylic acid, metal salicylate (Zn, Al, Ca or Mg salicylate), methanesulfonic acid, itaconic acid, benzenesulfonic acid, toluenesulfonic acid, trifluoromethanesulfonic acid, styrenesulfonic acid, trifluoroacetic acid, barbituric acid, acrylic acid, methacrylic acid, cinnamic acid, 4-hydroxybenzoic acid, aminobenzoic acid, naphthalenedisulfonic acid, hydroxybenzenesulfonic acid, toluenesulfinic acid, benzenesulfinic acid, sulfanilic acid, sulfamic acid, α-resorcylic acid, β-resorcylic acid, γ-resorcylic acid, gallic acid, fluoroglycine, sulfosalicylic acid, ascorbic acid, erysorbic acid, bisphenolic acid, hydrochloric acid, nitric acid, sulfuric acid, phosphoric acid, polyphosphoric acid, boric acid and boronic acid. The amount of the acid may be determined such that the pH of the surface of the ink-receiving layer is adjusted to 3 to 8.

The acid may be used in the form of a metal salt (for example, a salt of sodium, potassium, calcium, cesium, zinc, copper, iron, aluminum, zirconium, lanthanum, yttrium, magnesium, strontium or cerium) or an amine salt (for example, ammonia, triethylamine, tributylamine, piperazine, 2-methylpiperazine or polyallylamine).

In the invention, the ink-receiving layer preferably contains a storability improver such as a UV absorber, an antioxidant or a bleed inhibitor. Examples thereof include alkylated phenolic compounds (including hindered phenol compounds), alkylthiomethyl phenolic compounds, hydroquinone compounds, alkylated hydroquinone compounds, tocopherol compounds, thiodiphenyl ether compounds, compounds each having two or more thioether linkages, bisphenolic compounds, O-, N- and S-benzyl compounds, hydroxybenzyl compounds, triazine compounds, phosphonate compounds, acylaminophenolic compounds, ester compounds, amide compounds, ascorbic acid, amine-based antioxidants, 2-(2-hydroxyphenyl)benzotriazole compounds, 2-hydroxybenzophenone compounds, acrylate, water-soluble or hydrophobic metal salts, organometallic compounds, metal complexes, hindered amine compounds (including TEMPO compound), 2-(2-hydroxyphenyl)-1,3,5-triazine compound, metal inactivating agents, phosphite compounds, phosphonite compounds, hydroxyamine compounds, nitron compounds, peroxide scavengers, polyamide stabilizers, polyether compounds, basic assistant stabilizers, nucleating agents, benzofuranone compounds, indolinone compounds, phosphine compounds, polyamine compounds, thiourea compounds, urea compounds, hydrazide compounds, amidine compounds, sugar compounds, hydroxybenzoic acid compounds, dihydroxybenzoic acid compounds and trihydroxybenzoic acid compounds.

In a preferable embodiment, the ink-receiving layer contains at least one member selected from the group consisting of alkylated phenolic compounds, compounds each having two or more thioether linkages, bisphenolic compounds, ascorbic acid, amine-based antioxidants, water-soluble or hydrophobic metal salts, organometallic compounds, metal complexes, hindered amine compounds, polyamine compounds, thiourea compounds, hydrazide compounds, hydroxybenzoic acid compounds, dihydroxybenzoic acid compounds and trihydroxybenzoic acid compounds.

Specific examples of such compounds include the compounds described in JP-A No. 2002-13005, JP-A No. 10-182621, JP-A No. 2001-260519, JP-B No. 4-34953, JP-B No. 4-34513, JP-A No. 11-170686, JP-B No. 4-34512, EP1138509, JP-A No. 60-67190, JP-A No. 7-276808, JP-A No. 2001-94829, JP-A No. 47-10537, JP-A No. 58-111942, JP-A No. 58-212844, JP-A No. 59-19945, JP-A No. 59-46646, JP-A No. 59-109055, JP-A No. 63-53544, JP-B No. 36-10466, JP-B No. 42-26187, JP-B No. 48-30492, JP-B No. 48-31255, JP-B No. 48-41572, JP-B No. 48-54965, JP-B No. 50-10726, U.S. Pat. No. 2,719,086, U.S. Pat. No. 3,707,375, U.S. Pat. No. 3,754,919, U.S. Pat. No. 4,220,711, JP-B No. 45-4699, JP-B No. 54-5324, European Patent Laid-Open Nos. 223739, 309401, 309402, 310551, 310552 and 459-416, German Patent Laid-Open No. 3435443, JP-A No. 54-48535, JP-A No. 60-107384, JP-A No. 60-107383, JP-A No. 60-125470, JP-A No. 60-125471, JP-A No. 60-125472, JP-A No. 60-287485, JP-A No. 60-287486, JP-A No. 60-287487, JP-A No. 60-287488, JP-A No. 61-160287, JP-A No. 61-185483, JP-A No. 61-211079, JP-A No. 62-146678, JP-A No. 62-146680, JP-A No. 62-146679, JP-A No. 62-282885, JP-A No. 62-262047, JP-A No. 63-051174, JP-A No. 63-89877, JP-A No. 63-88380, JP-A No. 63-113536, JP-A No. 63-163351, JP-A No. 63-203372, JP-A No. 63-224989, JP-A No. 63-251282, JP-A No. 63-267594, JP-A No 63-182484, JP-A No. 1-239282, JP-A No. 2-262654, JP-A No. 2-71262, JP-A No. 3-121449, JP-A No. 4-291685, JP-A No. 4-291684, JP-A No. 5-61166, JP-A No. 5-119449, JP-A No. 5-188687, JP-A No. 5-188686, JP-A No. 5-110490, JP-A No. 5-170361, JP-B No. 48-43295, JP-B No. 48-33212, U.S. Pat. No. 4,814,262 and U.S. Pat. No. 4,980,275.

In addition to the surfactant and the hardener, the ink-receiving layer may further contain a wide variety of known additives such as: a fixing agent for a coloring dye, a coloring pigment and an ink dye; an UV absorber; an antioxidant; a pigment dispersant; a defoaming agent; a leveling agent; a preservative; a fluorescent brightener; a viscosity stabilizer; and a pH adjusting agent.

Only one additive may be used, or two or more additives may be used in combination. Such additives may be added in the form of a solution, dispersion, polymer dispersion, or emulsion, or in the form of oil droplets. As an alternative, such additives may be encapsulated in microcapsules. The amounts of such additives are preferably 0.01 to 10 g/m².

In the invention, the ink-receiving layer coating liquid may contain a surfactant. The surfactant to be used may be a cationic, anionic, nonionic, amphoteric, fluorine-based or silicone-based surfactant. Only one surfactant may be used, or two or more surfactants may be used in combination.

Examples of the nonionic surfactant include polyoxyalkylene alkyl ether and polyoxyalkylene alkyl phenyl ethers (for instance, diethylene glycol monoethyl ether, diethylene glycoldiethyl ether, polyoxyethylene laurylether, polyoxy ethylene stearylether, polyoxy ethylene nonylphenyl ether or the like), oxyethylene-oxypropylene blockcopolymers, sorbitan fatty acid esters (for instance, sorbitan mono laurate, sorbitan monooleate, sorbitan trioleate or the like), polyoxyethylene sorbitan fatty acid esters (for instance, polyoxyethylene sorbitan mono laurate, polyoxyethylene sorbitan monooleate, polyoxyethylene sorbitan trioleate or the like), polyoxyethylenesorbitol fatty acid esters (for instance, polyoxyethylene sorbit tetraoleate or the like), glycerin fatty acid esters (for instance, glycerol mono oleate or the like), polyoxyethylene glycerin fatty acid esters (polyoxyethylene glycerin monostearate, polyoxyethylene glycerin monooleate or the like), polyoxyethylene fatty acid esters (polyethylene glycol monolaurate, polyethylene glycol monooleate or the like), polyoxyethylene alkylamine, acetylene glycols (for instance, 2,4,7,9-tetramethyl-5-desin-4,7-diol, ethylene oxide adducts of 2,4,7,9-tetramethyl-5-desin-4,7-diol, propylene oxide adducts of 2,4,7,9-tetramethyl-5-desin-4,7-diol, or the like). Polyoxyalkylene alkylethers are preferable. The nonionic surfactant may be contained in the coating liquid for the ink receiving layer.

The amphoteric surfactant may be an amino-acid-based amphoteric surfactant, a carboxyammoniumbetaine-based amphoteric surfactant, a sulfoneammoniumbetaine-based amphoteric surfactant, an amphoteric surfactant based on ammonium sulfate ester betaine, and an imidazoliumbetaine-based amphoteric surfactant. Examples thereof include the amphoteric surfactants described in U.S. Pat. No. 3,843,368, JP-A Nos. 59-49535, 63-236546, 5-303205, 8-262742 and 10-282619. An amino-acid-based amphoteric surfactant is preferable as the amphoteric surfactant. The amino-acid-based amphoteric surfactant may be, for example, an amphoteric surfactant derivatized from an amino acid (glycine, glutamic acid, and histidine acid or the like) as described in JP-A No. 5-303205. Examples of the amino-acid-based amphoteric surfactant include an N-aminoacyl acid in which a long-chain acyl group is introduced and a salt of the N-aminoacryl acid.

Examples of the anionic surfactant include a fatty acid salt (for instance, sodium stearate or potassium oleate), an alkyl sulfate ester salt (for instance, sodium lauryl sulfate or triethanol amine lauryl sulfate), a sulfonate (for instance, sodium dodecylbenzenesulfonate), an alkylsulfo succinic acid salt (for instance, sodium dioctylsulfosuccinate), alkyldiphenylether disulfonate and alkyl phosphate. Examples of the cationic surfactant include an alkyl amine salt, a quaternary ammonium salt, a pyridinium salt, and an imidazolium salt.

Examples of the fluorine-based surfactant include compounds derived from an intermediate having a perfluoro alkyl group produced by a method such as electrolysis fluorination, telomerization and oligomerization. Examples include perfluoroalkyl sulfonate, perfluoroalkyl carboxylate, perfluoroalkyl ethyleneoxide adduct, perfluoroalkyl trialkyl ammonium salt, oligomers containing perfluoroalkyl groups, and perfluoro alkyl phosphate esters, and the like.

The silicone-based surfactant is preferably a silicone oil modified with an organic group or organic groups which may have a structure in which the side chain of the siloxane structure is modified with the organic group, a structure in which both of the terminals are modified with the organic groups, or a structure in which one of the terminals is modified with the organic group. Examples of the modification with an organic group include amino modification, polyether modification, epoxy modification, carboxyl modification, carbinol modification, alkyl modification, aralkyl modification, phenol modification, and fluorine modification.

The content of the surfactant in the ink-receiving layer coating liquid is preferably 0.001 to 2.0%, more preferably 0.01 to 1.0%. When two or more coating liquids are used for the formation of the ink-receiving layer, it is preferable that the surfactant is added to each coating liquid.

The ink-receiving layer in the invention preferably contains a high-boiling organic solvent for prevention of cracking and curling, and as the high-boiling organic solvent, a water-soluble or hydrophobic organic compound having a boiling point of 150° C. or more at normal pressure may be contained in the ink-receiving layer. The organic compound may be a low molecule or a polymer, and may be liquid or solid at room temperature.

The ink-receiving layer of the invention may comprise only one layer containing the inorganic fine particle dispersion liquid of the invention, or two or more layers each containing the inorganic fine particle dispersion liquid of the invention. When the ink-receiving layer comprises two or more layers each containing the inorganic fine particle dispersion liquid, the ink-receiving layer may comprise two layers including a layer containing silica fine particles and the other layer containing alumina hydrate.

### (Preparation of Inset Recording Medium)

The ink-receiving layer of the inkjet receiving medium of the invention can be formed preferably by a method (wet-on-wet [WOW] method) which comprises: applying an ink-receiving layer coating liquid (coating liquid A) containing at least vapor-phase-method silica, a water-soluble resin etc. onto the surface of a support; then applying a basic solution of pH 7.1 or higher (solution B) onto the coated layer either (1) simultaneously with the application of the coating liquid A or (2) during the drying of the coated layer formed by the application of the coating liquid A but before the coated layer shows a decreasing rate of drying; and then curing and crosslinking the resulting coated layer. The crosslinking agent for crosslinking the water-soluble resin is contained in at least one of the coating liquid A and the solution B. When the ink-receiving layer is cured and crosslinked as described above, the ink absorbing property can be improved and cracking of the layer can be prevented.

In the case of the WOW method described above, a mordant is preferably added to the solution B since, owing to the addition, the mordant is present mainly near the surface of the ink-receiving layer and sufficiently fixes inkjet recording ink (particularly dye), thus enabling the formation of high-density images and the improvement of the post-printing water-resistance of printed letters and images. A part of the mordant may be contained in the coating liquid A, and in this case, the mordant used in the coating liquid A may be the same as, or different from, the mordant in the solution B. The porous ink-receiving layer obtained in the manner described above can absorb ink rapidly through the capillary phenomenon, whereby dots with excellent circularity can be formed without ink bleed.

For example, the ink-receiving layer coating liquid containing at least vapor-phase-method silica, a water-soluble resin (for example PVA) and a crosslinking agent (for example a boron compound) can be prepared by mixing the vapor-phase-method silica and an aqueous PVA solution (containing PVA, for example, in such an amount as to give the ratio of PVA to vapor-phase-method silica of about 15%) and a boron compound and then subjecting the mixture to a dispersing treatment by a high-speed rotary homomixer (for example, T. K. homomixer (trade name) manufactured by Tokushu Kika Kogyo Co., Ltd.) under a high-speed revolution condition of, for example, 2000 rpm (preferably in the range of 1000 to 5000 rpm), for example for 20 minutes (preferably in the range of 10 to 30 minutes). The resulting coating liquid is in the form of uniform sol and can be applied and dried on a support by the coating method described later, to form a porous ink-receiving layer.

The particles in the ink-receiving layer coating liquid may be treated with a dispersing machine to form an aqueous dispersion liquid containing particles having a reduced average particle diameter of 10 to 120 nm. As the dispersing machine to be used to give the aqueous dispersion liquid, any of various known dispersing machines such as a disperser may be used. In view of the efficiency of dispersing flocculated fine particles, medium-stirring dispersing machines, colloid mill dispersing machines, and high-pressure dispersing machines are preferable.

The solvents for the preparation of the respective liquids may be selected from water, organic solvents, and mixed solvents thereof. Examples of organic solvents usable for coating include alcohols such as methanol, ethanol, n-propanol, i-propanol and methoxy propanol, ketones such as acetone and methyl ethyl ketone, tetrahydrofuran, acetonitrile, ethyl acetate, and toluene.

In the invention, the method for coating the coating liquid is not particularly limited, and may be selected from known coating methods. Examples of usable instruments include an extrusion die coater, an air doctor coater, a bread coater, a rod coater, a knife coater, a squeeze coater, a reverse roll coater, and a bar coater.

The basic solution (solution B) having a pH value of 7.1 or higher may be applied after coating a support with the ink-receiving layer coating liquid (coating liquid A), and this application can be carried out before the coated layer shows a decreasing rate of drying. That is, the ink-receiving layer is preferably produced by coating the support with the coating liquid A and then introducing the solution B during the period in which the coated layer shows a constant rate of drying.

The basic solution (solution B) having a pH value of 7.1 or higher may contain a crosslinking agent and/or a mordant as necessary. The pH value of the basic solution is 7.1 or higher, preferably 7.5 or higher, more preferably 8.0 or higher. When the pH value is lower than 7.1, the crosslinking agent fails to sufficiently promote the crosslinking reaction of the water-soluble polymer contained in the coating liquid A, thus generating failures such as cracking on the ink-receiving layer. The basic solution contains at least a basic substance and/or a salt of a basic substance. Examples of the basic substance include ammonia, a primary amine (ethylamine, polyallylamine etc.), a secondary amine (dimethylamine, triethylamine etc.), a tertiary amine (N-ethyl-N-methylbutylamine etc.), and a hydroxide of an alkali metal or alkaline earth metal.

The basic mordant coating liquid (basic solution B) can be prepared, for example by adding, as mordants (basic compounds), ammonium carbonate (for example, 1 to 10%) and ammonium zirconyl carbonate (for example, 0.5 to 7%) to deionized water and then stirring the mixture sufficiently. The term “%” in each composition refers to % by weight of solids content.

The expression “before the coated layer exhibits a decreasing rate of drying” usually refers to the period within a few minutes from the completion of the application of the ink receiving layer coating liquid. During the period, the coated layer exhibits a constant rate of drying in which the quantity of the solvent (dispersing medium) contained in the coated layer decreases in proportion to time. For instance, the period during which the coated layer exhibits a “constant rate of drying” is described in Chemical Engineering Handbook (pp. 707-712, Maruzen Co., Ltd., Oct. 25, 1980).

As described above, after coating of the ink-receiving layer coating liquid, the coated layer is dried until the coated layer exhibits a decreasing rate of drying. In general, the coated layer is dried at 40 to 180° C. (preferably, at 50 to 120° C.) for 0.5 to 10 minutes (preferably, for 0.5 to 5 minutes). The above-mentioned drying time is usually suitable though the drying time naturally depends on the coating amount.

Examples of methods for applying the solution B before the coated layer exhibits a decreasing rate of drying include (1) a method of further coating the solution B on the coated layer, (2) a method of spraying the solution B by a spray or the like, and (3) a method of immersing a support having the coated layer formed thereon in the solution B.

In the method (1), for instance, a known coating method using, for example, a curtain flow coater, an extrusion die coater, an air doctor coater, a bread coater, a rod coater, a knife coater, a squeeze coater, a reverse roll coater, or a bar coater may be used as the coating method for coating the solution B. It is preferable to use a method in which a coater does not directly contact with the already-formed coated layer, such as a method using an extrusion die coater, a curtain flow coater or a bar coater.

After the basic solution (solution B) is applied, the coated layer is heated in general at 40 to 180° C. for 0.5 to 30 minutes, whereby the coated layer is dried and hardened. In a preferable embodiment, the coated layer is heated at 40 to 150° C. for 1 to 20 minutes.

In an embodiment, the basic solution (solution B) is applied simultaneously with the application of the ink-receiving layer coating liquid (coating liquid A). In this embodiment, the coating liquid A and the solution B are applied simultaneously on the support (multi-layer coating) such that the coating liquid A is in contact with the support, and then dried and hardened to form the ink-receiving layer.

For instance, the simultaneous coating (multi-layer coating) can be performed by a coating method that uses an extrusion die coater or a curtain flow coater. After the simultaneous coating, the coated layer is dried. In the drying, in general, the coated layer is heated at 15 to 150° C. for 0.5 to 10 minutes, and more preferably at 40 to 100° C. for 0.5 to 5 minutes.

When the simultaneous coating (multi-layer coating) is performed by an extrusion die coater, two kinds of coating liquids to be discharged simultaneously come into contact with each other near the discharge port of the extrusion die coater before the coating liquids are moved onto the support, so that stacked layers are formed. The stacked layers are subjected to multi-layer coating on the support. When the stack of the two layers of the coating liquids is moved onto the support, the crosslinking reaction easily occurs in the interface of the two coating liquids. As a result, the two liquids easily mix with each other near the discharge port of the extrusion die coater to increase the viscosity, whereby there may be difficulty in the coating operation. Therefore, when the coating liquid A and the solution B are coated simultaneously as described above, it is preferable to further provide a barrier layer liquid (an intermediate layer liquid) between the coating liquid A and the solution B to conduct simultaneous coating of the three layers.

The barrier layer liquid can be selected without particular restrictions. The barrier layer liquid may be, for example, water or an aqueous solution containing a small amount of a water-soluble resin. The water-soluble resin is used as a viscosity improver or the like in consideration of coatability. Examples of the water-soluble resin include polymers such as cellulose-based resins (for instance, hydroxypropyl methylcellulose, methyl cellulose, hydroxy ethyl methyl cellulose, and the like), polyvinylpyrrolidone, and gelatin. The barrier layer liquid may contain a mordant.

The ink-receiving layer is preferably excellent in transparency. As a rough standard, when the ink-receiving layer is formed on a transparent film, the haze value of the ink-receiving layer is preferably 30% or less, and more preferably 20% or less. The haze value can be measured with a haze meter (trade name: HGM-2DP, manufactured by Suga Test Instrument Co., Ltd.).

A fine polymer particle dispersion may be added to one or more layers (for example, the ink-receiving layer) in the inkjet recording medium of the invention. The fine polymer particle dispersion is used for the purpose of improving physical properties of the film, such as stabilization of the dimensions, prevention of curling, prevention of adhesion and prevention of cracking on the film. The fine polymer particle dispersion is described in JP-A No. 62-245258, and JP-A No. 62-110066. When a dispersion of fine polymer particles having a low glass transition temperature (40° C. or less) is added to the ink-receiving layer, the cracking and curling of the layer can be prevented. Alternatively, curling can also be prevented by adding a dispersion of fine polymer particles having a high glass transition temperature to the back layer.

### (Support)

As the support, either a transparent support made of a transparent material such as plastics or an opaque support made of an opaque material such as paper can be used. A resin-laminated support comprising thermoplastic resin layers disposed on both sides of a base such as paper is preferable in the invention.

The support used in the present invention is preferably a water-resistant support. The support may be transparent or opaque. The thickness of the water-resistant support is preferably about 50 to 200 μm. Examples of such a support include resin films, a paper laminated with a polyolefin resin, a support having a sheet of paper laminated with a polyolefin resin such as polyethylene or polypropylene, and a glass plate. The resin of the resin films may be a polyester resin such as polyethylene terephthalate or polyethylene naphthalate, a diacetate resin, a triacetate resin, an acryl resin, a polycarbonate resin, polyvinyl chloride, a polyimide resin, cellophane, celluloid etc.

An opaque support having high glossiness in which the surface to be provided with the ink-receiving layer has a glossiness of 40% or more is preferable. The glossiness is a value determined according to the method described in JIS P-8142 (testing method for 75 degree specular glossiness of paper and board). Examples of the support include the following supports.

Examples include paper supports having high glossiness such as art paper, coat paper, cast coat paper and baryta paper for a support of a silver salt photography; polyesters such as polyethylene terephthalate (PET), cellulose esters such as nitrocellulose, cellulose acetate and cellulose acetate butyrate, opaque high glossiness films obtained by incorporation of white pigment or the like to plastic films such as polysulfone, polyphenylene oxide, polyimide, polycarbonate and polyamide (a surface calendar treatment may be performed); and a support in which a polyolefin coating layer optionally containing a white pigment is provided on the surface of any of the various paper supports, transparent supports, and high glossiness films containing white pigments or the like. A foam polyester film containing white pigment (for instance, a foam PET which contains the polyolefin fine particles and also contains voids formed by stretching) is also preferable.

The resin-coated support may be, for example, a support in which thermoplastic resin layers are provided on both sides of highly glossy paper base such as art paper, coat paper, cast coat paper and baryta paper for a support of a silver salt photography, or a resin coat paper for a support of a photographic paper for silver salt photography.

The thickness of the opaque support is not particularly limited, and is preferably 50 to 300 μm in view of handling property.

The surface of the support may be subjected to a corona discharge treatment, a glow discharge treatment, a flame treatment, a ultraviolet irradiation treatment or the like so as to improve wettability and adhesion property.

Hereinafter, the paper laminated with polyolefin resin is described in detail.

The base paper of the paper laminated with polyolefin resin is not particularly limited, and may be a generally-used paper, preferably a smooth base paper such as used in a photographic support. The pulp constituting the base paper may be a natural pulp, a regenerated pulp or a synthetic pulp, or a mixture of two or more of such pulps.

The base paper is provided with additives generally used in paper making, such as a sizing agent, a paper strength enhancer, a filler, an antistatic agent, a fluorescent brightener and a dye.

The thickness of the base paper is not particularly limited, and the base paper preferably has excellent surface smoothness. Superior surface smoothness can be achieved, for example by applying pressure by calendering or the like during or after paper manufacturing, and the base weight of the base paper is preferably 30 to 250 g/m².

As the resin in the resin-laminated paper, a polyolefin resin or a resin curable by irradiation with electron rays may be used. The polyolefin resin may be a homopolymer of an olefin, such as low-density polyethylene, high-density polyethylene, polypropylene, polybutene or polypentene, or a copolymer of two or more olefins, such as an ethylene/propylene copolymer, or a mixture thereof. One polyolefin resin selected from various polyolefin resins different in density and melt index may be used alone or a mixture of two or more polyolefin resins selected from various polyolefin resins different in density and melt index may be used.

It is preferable to incorporate a suitable combination of various additives into the resin in the resin-laminated paper. Examples of additives include white pigments such as titanium oxide, zinc oxide, talc and calcium carbonate, amides of fatty acids such as stearic amide, arachidic amide etc., fatty acid metal salts such as zinc stearate, calcium stearate, aluminum stearate, magnesium stearate etc., antioxidants such as IRGANOX 1010, IRGANOX 1076 etc., blue pigments and dyes such as cobalt blue, ultramarine, cicilian blue, phthalocyanine blue etc., magenta pigments and dyes such as cobalt violet, Fast Violet, manganese violet etc., fluorescent brighteners, UV absorbers etc.

When the resin in the resin-laminated paper suitable as a support used in the invention is a polyolefin resin, the resin-laminated paper can be produced by an extrusion coating method in which the polyolefin resin in the heat-molten state is cast on a running base paper, whereby both surfaces of the base paper is laminated with the resin. When a resin curable with electron rays is used, the resin is applied onto a base paper by a generally-used coater such as a gravure coater or a blade coater, and then irradiated with electron rays, whereby the resin is cured and laminated on the base paper. Prior to lamination of the resin on the base paper, the base paper is preferably subjected to an activation treatment such as corona discharge treatment or flame treatment. The surface (front surface) of the support to be provided with the ink-receiving layer may be a matting surface, a glossy surface, or the like depending on the application, and is preferably glossy. It is not necessary to laminate the opposite surface (back surface) of the support with the resin. However, it is preferable to laminate the back surface with the resin in view of the prevention of curling. The back surface is usually a non-glossy surface. The front surface (and also on the back surface if necessary) may be subjected to an activation treatment such as a corona discharge treatment, a flame treatment or the like. The thickness of the resin-laminated layer is not particularly limited. Usually, the resin is applied to a thickness of 5 to 50 μm on the front surface, or on each of the front and back surfaces.

The support in the invention may be provided with any of various backcoat layers for the purposes of preventing charging and curling and of improving transferability and curling. The backcoat layer may contain a suitable combination of substances selected from inorganic antistatic agents, organic antistatic agents, hydrophilic binders, latexes, hardeners, pigments, surfactants and the like.

The material usable for the transparent support is preferably a transparent material resistant to radiation heat at the time of being used on an OHP or backlight display. Examples of the material include polyesters such as polyethylene terephthalate (PET), as well as polysulfone, polyphenylene oxide, polyimide, polycarbonate, polyamide etc. Among these, polyesters are preferable, and polyethylene terephthalate is particularly preferable. The thickness of the transparent support is not particularly limited, and is preferably 50 to 200 μm in view of easy handling.

Next, resin-coated paper will be described in detail. The base paper comprises wood pulp as the main raw material, and optionally comprises a synthetic pulp such as polypropylene and/or a synthetic fiber such as nylon or polyester as necessary, in addition to the wood pulp. Any of LBKP, LBSP, NBKP, NBSP, LDP, NDP, LUKP and NUKP can be used as the wood pulp. It is preferable to use a higher proportion of pulps containing short fibers at higher ratios, such as LBKP, NBSP, LBSP, NDP and LDP. The ratio of LBSP and/or LDP is preferably in the range of 10% by weight to 70% by weight. A chemical pulp with few impurities (sulfate pulp and sulfite pulp) is preferably used as the pulp, and a pulp whose whiteness has been improved by bleaching, is also useful.

The base paper may be provided with additives, as necessary. Examples of the additives include sizing agents such as higher fatty acids and alkyl ketene dimers, white pigments such as calcium carbonate, talc and titanium oxide, paper-strength improving agents such as starch, polyacrylamide and polyvinyl alcohol, fluorescent whitening agents, water retention agents such as polyethylene glycols, dispersing agents, and softening agents such as quaternary ammonium.

The freeness of the pulp used for papermaking is preferably 200 to 500 ml in terms of CSF. With respect to the length of the fibers after beating, the sum of 24 mesh remainder and the 42 mesh remainder is preferably 30 to 70% by weight according to JIS P-8207. The quantity of the 4 mesh remainder is preferably 20% by weight or less. The basic weight of the base paper is preferably 30 to 250 g, and more preferably 50 to 200 g. The thickness of the base paper is preferably 40 to 250 μm. High flatness can be imparted to the base paper by a calendar treatment in the paper-making or after paper-making. The density of the base paper is generally 0.7 to 1.2 g/m² (JIS P-8118). In addition, the stiffness of the base paper is preferably 20 to 200 g in the condition specified in JIS P-8143.

A surface sizing agent may be coated on the surface of the base paper, and the sizing agent may be selected from the above-described sizing agents that can be incorporated into the base paper. The pH of the base paper is preferably 5 to 9 when measured by a hot water extraction method according to JIS P-8113.

In general, the both surfaces of the base paper may be laminated with a polyethylene. The polyethylene may mainly comprise a polyethylene (LDPE) having a low density and/or, a polyethylene (HDPE) having a high density, and may further comprise a small amount of other LLDPE, polypropylene, etc.

Especially, the polyethylene layer on the side to be provided with the ink-receiving layer is preferably a polyethylene layer obtained by adding one or more substances selected from rutile-type or anatase-type titanium oxide, a fluorescent whitening agent and a ultramarine blue pigment to polyethylene, thereby improving the opaque degree, the whiteness and the color hue, as is performed widely in a printing paper for photography. The content of titanium oxide is preferably about 3 to 20% by weight, and more preferably 4 to 13% by weight, based on the weight of polyethylene. The thickness of the polyethylene layer on each of the front and back surfaces is not particularly limited, and is preferably 10 to 50 μm. Further, an undercoat layer may be provided so as to enable tight adhesion between the ink-receiving layer and the polyethylene layer. The undercoat layer preferably comprises one or more substances selected from aqueous polyester, gelatin, and PVA. The thickness of the undercoat layer is preferably 0.01 to 5 μm.

The polyethylene-coated paper may be used as glossy paper. In another embodiment, similarly to usual photographic papers, a sheet of paper having a matt surface is used which is obtained by performing a so-called imprinting treatment at the time polyethylene is coated on the surface of the base paper by melt-extrusion.

The support may have a backcoat layer. Examples of the components that can be added to the backcoat layer include white pigments, aqueous binders, and other components. The white pigments usable in the backcoat layer may be selected from inorganic white pigments and organic pigments. Examples of inorganic white pigments include light calcium carbonate, heavy calcium carbonate, kaolin, talc, calcium sulfate, barium sulfate, titanium dioxide, zinc oxide, zinc sulfate, zinc carbonate, satin white, aluminum silicate, diatomaceous earth, calcium silicate, magnesium silicate, synthetic amorphous silica, colloidal silica, colloidal alumina, pseudo boehmite, aluminum hydroxide, alumina, lithopone, zeolite, hydrated halloysite, magnesium carbonate, and magnesium hydroxide. Examples of organic pigments include styrene-based plastic pigments, acryl-based plastic pigments, polyethylene, microcapsules, urea resins, and melamine resins.

The aqueous binder used in the backcoat layer may be a water-soluble polymer or a water-dispersible polymer. Examples of the water-soluble polymer include a styrene-maleic acid salt copolymer, a styrene-acrylic acid salt copolymer, polyvinyl alcohol, silanol-modified polyvinyl alcohol, starch, cationized starch, casein, gelatin, carboxymethyl cellulose, hydroxyethyl cellulose and polyvinyl pyrrolidone. Examples of the water-dispersible polymer include styrene butadiene latex and acrylic emulsion. The backcoat layer may further contain other components such as a defoaming agent, a foaming inhibitor, a dye, a fluorescent brightener, a preservative, and a water-resistance imparting agent. The disclosures of Japanese patent Application Nos. 2004-329634, 2005-29771, and 2005-272815 are incorporated herein by reference.

### EXAMPLES

Hereinafter, the present invention is described in more detail by reference to Examples, but Examples should not be construed as limiting the invention. In Examples, the terms “parts” and “%” refer to “parts by weight” and “% by weight”, respectively.

### (Preparation of a Support)

Wood pulp composed of 100 parts of LBKP was refined by a double disk refiner to a Canadian freeness of 300 ml, and 0.5 part of epoxydized behenic amide, 1.0 part of anionic polyacrylamide, 0.1 part of polyamide polyamine epichlorohydrin and 0.5 part of cationic polyacrylamide (the amounts being expressed in terms of the bone-dry weight ratios of the components to the pulp), were added and weighed by a wire paper machine to prepare a base paper of 170 g/m².

For the regulation of the surface size of the base paper, the base paper was impregnated, in an amount of 0.5 g/m² on the bone-dry weight basis, with a 4% aqueous polyvinyl alcohol solution containing 0.04% of a fluorescent brightener (trade name: WHITEX BB, manufactured by Sumitomo Chemical Co., Ltd.), then dried and calendered, so that the density of the base paper was adjusted to 1.05 g/ml.

The wire surface (back surface) of the resultant base paper was subjected to a corona discharge treatment and then coated with a high-density polyethylene to a thickness of 19 μm by a melt extrusion machine, so that a resin layer having a matte surface (hereinafter, the surface of the resin layer is referred to as “back surface”) was formed. The resin layer forming the back surface was further subjected to a corona discharge treatment and then coated, in an amount of 0.2 g/m² on a dry weight basis, with a dispersion liquid containing, as an antistatic agent, aluminum oxide (ALUMINA SOL 100 manufactured by Nissan Chemical Industries, Ltd.) and colloidal silicon dioxide (SNOWTEX 0 manufactured by Nissan Chemical Industries, Ltd.) in the ratio of 1:2 (ratio by weight) dispersed in water.

The felt surface (front surface) not having the resin layer was subjected to a corona discharge treatment, and then a low-density polyethylene having a MRF (melt flow rate) of 3.8 which contained 10% (relative to the polyethylene) of anatase-type titanium dioxide, a trace amount of ultramarine and 0.01% (relative to the polyethylene) of a fluorescent brightener was melt-extruded to a thickness of 40 μm onto the felt surface by a melt extrusion machine, to form a highly glossy thermoplastic resin layer on the front surface of the base paper (hereinafter, this highly glossy surface is referred to as “front surface”). The resultant base having the resin layer and the thermoplastic resin layer was used as a support.

### Example 1

A fine silica dispersion liquid was prepared in the following manner.

### (Preparation of fine Silica Dispersion Liquid A-1)

25 parts of a vapor-phase-method silica (having an average primary particle diameter of 7 nm and a specific surface area of 300 m²/g as determined by BET method) (referred to hereinafter as silica) was added to 553 parts of deionized water under stirring at 2000 rpm with a homomixer, and then 0.33 part of dimethyl diallyl ammonium chloride (SHAROL DC902P, 50% aqueous solution, manufactured by Dai-ichi Kogyo Seiyaku Co., Ltd.) was added, and then 50 parts of the silica was further added, and then 0.67 part of dimethyl diallyl ammonium chloride (SHAROL DC902P, 50% aqueous solution, manufactured by Dai-ichi Kogyo Seiyaku Co., Ltd.) was added, and then 25 parts of the silica was added, and then 0.54 part of zirconyl acetate (ZIRCOZOL ZA-30, 50% aqueous solution, manufactured by Daiichi Kigenso Kagaku Kogyo Co., Ltd.) as a water-soluble polyvalent metal compound was added and dissolved, and the mixture was treated at 30° C. for 120 minutes at 4000 rpm with a homomixer (T. K. HOMODISPER manufactured by Tokushu Kika Kogyo Co., Ltd.) to prepare a preliminary silica dispersion liquid. This preliminary dispersion liquid was further dispersed at 130 MPa with one-pass by a liquid-liquid collision-type dispersing machine (ALTIMIZER, manufactured by Sugino Machine Incorporated.) to prepare a fine silica dispersion liquid containing the silica at a concentration of about 15 wt %.

### (Preparation of Ink-Receiving Layer Coating Liquid A-1)

### <Preparation of a Co-Dissolved Product of Polyvinyl Alcohol, Diethylene Glycol Monobutyl Ether (BUTYSENOL 20P), and EMULGEN 109P>

The following ingredients were mixed under cooling and then heated to 90° C. to dissolve the ingredients. A solution containing PVA was obtained in this way.

| | | |
|---|---|---|
| Deionized water | 88.6 | parts |
| EMULGEN 109P (manufactured by Kao Corporation) | 0.23 | part |
| BUTYSENOL 20P (manufactured by Kyowa Hakko | 2.1 | parts |
| Chemical) | | |
| Polyvinyl alcohol (PVA 235 manufactured by Kuraray, | 7.0 | parts |
| with a saponification degree of 88.5% and a polymerization | | |
| degree of 3500) | | |

Then, the solution containing PVA (2) obtained above and the following components (3) to (7) were added to the fine silica dispersion liquid A-1 (1) obtained above. The mixture was subjected to a dispersing treatment for 20 minutes at 2000 rpm with T. K. HOMODISPER (Tokushu Kika Kogyo Co., Ltd.) to prepare an ink-receiving layer coating liquid A-1 consisting of the following composition.

### <Composition of the Ink-Receiving Layer Coating Liquid A-1>

| | | |
|---|---|---|
| (1) | Fine silica dispersion liquid A-1 | 58.9 parts |
| (2) | The solution containing 7.61% of PVA | 31.2 parts |
| | (water-soluble resin) | |
| (3) | Boric acid (crosslinking agent) | 3.9 parts |
| (4) | Deionized water | 1.3 parts |
| (5) | SUPERFLEX 650 (manufactured by Dai-ichi Kogyo | 2.2 parts |
| | Seiyaku Co., Ltd.) | |
| (6) | Ethanol | 1.2 parts |
| (7) | Polyaluminum chloride (ALFINE 83, Taimei Kagaku) | 1.3 parts |

Then, the respective components in the following composition were mixed to give a mordant coating liquid B.

### <Composition of Mordant Coating Liquid B>

| | | |
|---|---|---|
| (1) | Boric acid (crosslinking agent) | 0.65 part |
| (2) | Ammonium carbonate (first-grade reagent, | 5.0 parts |
| | manufactured by Kanto Kagaku) | |
| (3) | Ammonium zirconyl carbonate (13% aqueous | 1.27 parts |
| | solution) (ZIRCOZOL AC-7, manufactured by Daiichi | |
| | Kigenso Kagaku Kogyo Co., Ltd.) | |
| (4) | Deionized water | 87.08 parts |
| (5) | EMULGEN 109P (10% aqueous solution) | 6.0 parts |
| | (manufactured by Kao Corporation) | |

### Preparation of Inkjet Recording Sheet

A corona electrical discharge treatment was conducted on the front surface of the support obtained as described above, and the ink-receiving layer coating liquid A was coated on the front surface by using an extrusion die coater in a coating amount of 175 ml/m² (coating process). The coated layer was dried at 80° C. (wind velocity: 3 to 8 m/sec) in a hot air dryer until the solid content of the coated layer became 20%. During the drying, the coated layer showed constant-rate of drying. The support was immersed in the mordant coating liquid B for 3 seconds before the coated layer showed decreasing rate of drying, and the mordant coating liquid B in an amount of 15 g/m² adhered onto the coated layer. The coated layer was then dried at 80° C. for 10 minutes (curing process). As the result, an inkjet recording sheet of the invention having the ink-receiving layer with a dry film thickness of 35 μm was obtained. The surface of the ink-receiving layer had a pH of 4.1.

### Example 2

### (Preparation of Fine Silica Dispersion Liquid A-2)

A fine silica dispersion liquid was prepared in the same manner as the preparation of A-1 in Example 1 except that 531 parts of deionized water was added in place of 553 parts of deionized water, and except that 22 parts of a ethyl alcohol was added.

### (Preparation of Ink-Receiving Layer Coating Liquid A-2)

Ink-receiving layer coating liquid A-2 was prepared in the same manner as in Example 1 except that the fine silica dispersion liquid A-2 was used in place of the fine silica dispersion liquid A-1.

### (Preparation of Inkjet Recording Sheet)

The inkjet recording sheet of Example 2 was prepared in the same manner as in Example 1 except that the ink-receiving layer coating liquid A-2 was used in place of the ink-receiving layer coating liquid A-1. The pH of the surface of the ink-receiving layer was 4.0.

### Example 3

An inkjet receiving layer coating liquid and an inkjet recording sheet were prepared in the same manner as in Example 1 except that at the time of preparing the fine silica dispersion liquid, the silica slurry was passed once through an orifice at a processing pressure of 80 MPa by using a high-pressure homogenizer (NANOMIZER LA-31 manufactured by Nanomizer) in place of ALTIMIZER.

### Example 4

A fine silica dispersion liquid, an ink-receiving layer coating liquid and an inkjet recording sheet were prepared in the same manner as in Example 1 except that the pressure of ALTIMIZER at the preparation of the fine silica dispersion liquid was changed into 70 MPa.

### Comparative Example 1

A fine silica dispersion liquid, an ink-receiving layer coating liquid and an inkjet recording sheet were prepared in the same manner as in Example 1 except that in the preparation of the fine silica dispersion liquid, the silica was dispersed by a sand grinder dispersing machine (DYNOMILL manufactured by Shinmaru Enterprises Corporation) in place of the liquid-liquid collision-type dispersing machine (ALTIMIZER manufactured by Sugino Machine Incorporated.).

### Comparative Example 2

A fine silica dispersion liquid, an ink-receiving layer coating liquid and an inkjet recording sheet were prepared in the same manner as in Example 1 except that zirconyl acetate as a water-soluble polyvalent metal compound was not used in the fine silica dispersion liquid.

### Comparative Example 3

An ink-receiving layer coating liquid and an inkjet recording sheet were prepared in the same manner as in Example 1 except for using, in place of fine silica dispersion liquid A-1, a preliminary silica dispersion liquid which was obtained in the same manner as the preparation of the preliminary silica dispersion liquid prepared in Example 1 except that the duration of the stirring-dispersing by the T. K. homodisper in the preparation of the preliminarily dispersion liquid was changed to 240 minutes. The particle diameter of the preliminarily silica dispersion liquid is shown in the column with the heading “Inorganic fine particle dispersion liquid” in Table 1 below.

### Comparative Example 4

A fine silica dispersion liquid, an ink-receiving layer coating liquid and an inkjet recording sheet were prepared in the same manner as in Example 1 except that in the preparation of the fine silica dispersion liquid, the cationic resin SHAROL DC902P was not used.

### Comparative Example 5

A fine silica dispersion liquid, an ink-receiving layer coating liquid and an inkjet recording sheet were prepared in the same manner as in Example 1 except that the pressure at dispersing the silica by using ALTIMIZER was changed to 40 MPa in the preparation of the fine silica dispersion liquid.

The inkjet recording sheets prepared as described above were evaluated with respect to the surface state and ink absorbing property of the ink-receiving layer according to the following criteria. The results are shown in Table 1.

### <Evaluation of the Coating Surface>

### A: The coating surface is excellent in gloss when viewed with the naked eye.

### B: The coating surface is recognized to be poor in gloss when viewed with the naked eye.

### C: The coating surface does not have gloss when viewed with the naked eye.

### <Transparency>

The absorbance values of the resulting fine silica dispersion liquid and ink-receiving layer coating liquid were measured at 500 nm by a spectrophotometer V-570 manufactured by JASCO Corporation. A lower absorbance is indicative of higher transparency of the coating liquid.

### <Ink Absorbing Property>

A black solid image was printed on each inkjet recording sheet by using PMG-800 color printer (manufactured by Seiko Epson Corporation) under the conditions of ordinary temperature and ordinary humidity. Just after printing, a sheet of PPC paper was placed on and moderately pressed against the printed portion. The degree of transfer of ink to the sheet of PPC paper was observed with the naked eye and evaluated according to the following criteria.

### A: No transfer.

### B: Sight transfer.

### C: Significant transfer.

### <Particle Diameter>

The particle diameter (median diameter) of the silica fine particles in the resulting dispersion liquid was measured with HORIBALA-920.

### <Measurement of Printing Density>

A solid black image was printed on each of the inkjet recording sheets obtained in the Examples and Comparative Examples by using an inkjet printer PMG800C (manufactured by Seiko Epson Corporation), and the image density of the resultant black image portion was measured with a reflection densitometer (XRITE 938 manufactured by Xrite Incorporated.). The results are shown in Table 1 below.

TABLE 1

| | | | | | Inorganic fine particle dispersion | | | Ink-receiving | | | |
|---|---|---|---|---|---|---|---|---|---|---|---|
| | | | Water- | Water- | liquid | | | layer coating | Inkjet recording sheet | | |
| | | | soluble | soluble | Particle | Coarse | | liquid | Gloss | | |
| | | Inorganic | organic | polyvalent | diameter | particles | Absorbance | Absorbance | of the | Black | |
| | Dispersing | fine | cationic | metal | (median | (5 μm or | at | at | coating | density | Transfer- |
| | Treatment | particles | compound | compound | diameter) | larger) | 500 nm | 500 nm | surface | K-Dm | ability |
| Example 1 | Liquid-liquid | present | present | present | 108 nm | 0% | 0.64 | 0.70 | A | 2.30 | A |
| | collision-type | | | | | | | | | | |
| | ALTIMIZER | | | | | | | | | | |
| Example 2 | Liquid-liquid | present | present | present | 110 nm | 0% | 0.62 | 0.68 | A | 2.30 | A |
| | collision-type | | | | | | | | | | |
| | ALTIMIZER | | | | | | | | | | |
| Example 3 | Orifice | present | present | present | 110 nm | 0% | 0.66 | 0.75 | A | 2.27 | A |
| | passage-type | | | | | | | | | | |
| | high-pressure | | | | | | | | | | |
| | homogenizer | | | | | | | | | | |
| Example 4 | Liquid-liquid | present | present | present | 120 nm | 0% | 0.68 | 0.73 | A | 2.25 | A |
| | collision-type | | | | | | | | | | |
| | ALTIMIZER | | | | | | | | | | |
| Comparative | Sand grinder | present | present | present | 145 nm | 0% | 1.4 | 1.7 | C | 2.00 | A |
| Example 1 | dispersing | | | | | | | | | | |
| | machine | | | | | | | | | | |
| Comparative | Liquid-liquid | present | present | absent | 112 nm | 0% | 0.62 | 0.69 | B | 2.25 | A |
| Example 2 | collision-type | | | | | | | | | | |
| | Altimizer | | | | | | | | | | |
| Comparative | Homodisper | present | present | present | 18 μm | 96% | 2.1 | 2.2 | C | 1.10 | A |
| Example 3 | only | | | | | | | | | | |
| Comparative | Liquid-liquid | present | absent | present | 112 nm | 0% | 0.68 | 0.71 | B | 2.28 | A |
| Example 4 | collision-type | | | | | | | | | | |
| | ALTIMIZER | | | | | | | | | | |
| Comparative | Liquid-liquid | present | present | present | 150 nm | 10% | 0.92 | 1.02 | A | 2.30 | A |
| Example 5 | collision-type | | | | | | | | | | |
| | ALTIMIZER | | | | | | | | | | |

As is clear from the results shown above, the inkjet recording sheets using the dispersions of the invention were excellent in coating surface gloss. Further, they were excellent in any of ink absorption speed, image density and water resistance.

1. A method of producing an inorganic fine particle dispersion liquid, the method comprising subjecting a dispersion liquid including a water-soluble organic cationic compound, a water-soluble polyvalent metal compound, and inorganic fine particles to a dispersing process by a head-on collision high-pressure dispersing machine or an orifice-passage high-pressure dispersing machine.

2. The method of producing an inorganic fine particle dispersion liquid according to claim 1, wherein the processing pressure of the head-on collision high-pressure dispersing machine is 50 MPa or more.

3. The method of producing an inorganic fine particle dispersion liquid according to claim 1, wherein a difference between a pressure of an entry-side of an orifice of the orifice-passage high-pressure dispersing machine and a pressure of an exit-side of the orifice of the orifice-passage high-pressure dispersing machine is 50 MPa or more.

4. The method of producing an inorganic fine particle dispersion liquid according to any one of claims 1 to 3, wherein an average primary particle diameter of the inorganic fine particles is 30 nm or less, and an average secondary particle diameter of the inorganic particles after the dispersing process is 200 nm or less.

5. The method of producing an inorganic fine particle dispersion liquid according to any one of claims 1 to 4, wherein the inorganic fine particles are vapor-phase-method silica particles.

6. The method of producing an inorganic fine particle dispersion liquid according to any one of claims 1 to 5, wherein a specific surface area, according to a BET method, of the inorganic fine particles is 200 m²/g or larger.

7. The method of producing an inorganic fine particle dispersion liquid according to any one of claims 1 to 6, wherein the water-soluble polyvalent metal compound is a tri- or higher-valent metal compound.

8. The method of producing an inorganic fine particle dispersion liquid according to claim 7, wherein the tri- or higher-valent metal compound is a water-soluble aluminum compound and/or a water-soluble zirconium compound.

9. The method of producing an inorganic fine particle dispersion liquid according to any one of claims 1 to 8, wherein the water-soluble organic cationic compound is a compound having a group selected from a primary amino group, a secondary amino group, a tertiary amino group, a quaternary ammonium base, and a phosphonium base.

10. The method of producing an inorganic fine particle dispersion liquid according to any one of claims 1 to 9, wherein the water-soluble polyvalent metal compound includes at least one compound selected from zirconyl acetate, zirconyl ammonium carbonate, and basic polyaluminum hydroxide.

11. An inorganic fine particle dispersion liquid, wherein the inorganic fine particle dispersion liquid is prepared by the method of producing an inorganic fine particle dispersion liquid according to any one of claims 1 to 10.

12. An inkjet recording medium comprising an ink-receiving layer prepared by application of a coating liquid including the inorganic fine particle dispersion liquid of claim 11.

13. The inkjet recording medium according to claim 12, wherein the coating liquid further includes a water-soluble resin, a crosslinking agent, and a surfactant.

14. The inkjet recording medium according to claim 12 or 13, wherein the coating liquid further includes a water-soluble resin, a crosslinking agent, a surfactant, a water-soluble organic solvent having a boiling point of 150° C. or more, and a water-dispersible cationic resin.

15. The inkjet recording medium according to claim 13 or 14, wherein the water-soluble resin is a polyvinyl-alcohol-based resin.

16. The inkjet recording medium according to claim 14 or 15, wherein the water-soluble resin, the surfactant, and a water-soluble organic solvent having a boiling point of 150° C. or more are dissolved in an aqueous solution before being added to the coating liquid.

17. The inkjet recording medium according to any one of claims 13 to 16, wherein the crosslinking agent is boric acid.

18. The inkjet recording medium according to any one of claims 13 to 17 comprising a water-dispersible cationic resin, wherein the water-dispersible cationic resin is a urethane resin.
